(19) United States
(12) Patent Application Publication
(10) Pub. No.: US 2011/0105273 A1
(43) Pub. Date: May 5, 2011

(54) CONTINUOUSLY VARIABLE TRANSMISSION

(75) Inventors: Motoki Tabuchi, Mishima-shi (JP); Masami Sugaya, Shizuoka-ken (JP)

(73) Assignee: TOYOTA JIDOSHA KABUSHIKI KAISHA, TOYOTA-SHI (JP)

(21) Appl. No.: 13/001,794

(22) PCT Filed: Dec. 15, 2008
(86) PCT No.: PCT/JP2008/072772

§ 371 Date: Dec. 29, 2010

(51) Int. Cl. F16H 61/664

(52) U.S. Cl. 476/10

(57) ABSTRACT

A continuously variable transmission includes a transmission ratio changing unit that can change a transmission ratio as a rotation speed ratio of an input disc and an output disc by tiltably rotating a power roller, a nip-press unit that can apply nip-pressure that nips the power roller between the input disc and the output disc by a pressure of a working medium supplied from a hydraulic pressure controlling unit that controls the pressure of the working medium to a nip-pressure generation hydraulic chamber via a coupling oil passage, and a pressure release unit which is disposed to the coupling oil passage and can release the pressure of the working medium of the nip-pressure generation hydraulic chamber via the release unit in response to an operation state, wherein since the release unit is positioned upward in a vertical direction of the nip-pressure generation hydraulic chamber in a state that the pressure release unit is mounted on a vehicle, the pressure release unit can appropriately prevent an unintentional transmission shift.

### TECHNICAL FIELD

The present invention relates to a continuously variable transmission, and in particular to a so-called toroidal type continuously variable transmission in which a transmission ratio is changed by a movement of a power roller interposed between an input disc and an output disc.

### BACKGROUND ART

In general, to transmit a driving force that is, output torque from an internal combustion engine and a motor as a drive source to a road surface in an optimum condition in response to a traveling state of a vehicle, the vehicle is disposed with a transmission on an output side of the drive source. The transmission includes a continuously variable transmission which controls a transmission ratio non-stepwise (continuously) and a non-continuously variable transmission which controls a transmission ratio stepwise (non-continuously). The continuously variable transmission, that is, a so-called continuously variable transmission (CVT) includes, for example, a so-called toroidal type continuously variable transmission which transmits torque between respective discs via a power roller nipped between an input disc and an output disc as well as changes a transmission ratio by tiltably rotating the power roller.

The toroidal type continuously variable transmission nips a rotation means such as a power roller, which has an outer peripheral surface to which a curved surface corresponding to a toroidal surface is formed, between the input disc and the output disc each having the toroidal surface and transmits torque making use of a shear force of traction oil films formed between the input disc, output disc, and the power roller. The power roller is rotatably supported by a trunnion, and the trunnion is configured such that it can be rotated about a rotating shaft as well as can be moved in a direction along the rotating shaft by, for example, acting a transmission shift control pressure force on a piston disposed to the trunnion by a hydraulic pressure of a working oil supplied to a transmission shift control hydraulic pressure chamber. Accordingly, when the power roller supported by the trunnion moves from a neutral position with respect to the input disc and the output disc to a transmission shift position together with the trunnion, since a tangential line force acts between the power roller and the discs and a side slip is generated, the power roller rotates, that is, tiltably rotates about the rotating shaft with respect to the input disc and the output disc. As a result, a transmission ratio, which is a number of revolution ratio between the input disc and the output disc, is changed. The transmission ratio, which is the number of revolution ratio between the input disc and the output disc, is determined based on an angle at which the power roller tiltably rotates with respect to the input disc and the output disc, that is, based on a tiltable rotation angle, and the tiltable rotation angle is determined based an integration value of a stroke amount (offset amount) as a moving amount of the power roller from the neutral position to the transmission shift position side.

The toroidal type continuously variable transmission acts a predetermined nip-pressure, which nips the power roller between the input disc and the output disc, by, for example, a nip-press means, thereby keeping an appropriate traction state in contact portions of the input disc, the output and the power roller.

A continuously variable transmission described in, for example, Patent Document 1 as the conventional toroidal type continuously variable transmission secures a surface pressure of a traction unit, which is configured of inside surfaces of both input and output side discs and a peripheral surface of a power roller by a hydraulic press device (nip-press means), and when an output shaft coupled with an output disc side stops or rotates at a very low speed, a press force generated by the press device is reduced. With the operation, since a creep ratio of the traction unit increases, the continuously variable transmission suppresses a torque variation of the output shaft by suppressing torque transmitted to the output shaft to a low level.

Patent Document 1: Japanese Patent Application Laid-open No. 2004-211836

### DISCLOSURE OF THE INVENTION

### Problems to be Solved by the Invention

Incidentally, in the toroidal type continuously variable transmission, when the power roller and the trunnion which supports the power roller are located at a neutral position, the toroidal type continuously variable transmission acts a transmission shift control press force, which has a magnitude that resists a tangential force acting on contact points of an input disc, an output disc and the power roller, on a piston of the trunnion in response to input torque and balances the tangential force acting on the power roller with the transmission shift control press force, thereby fixing a position of the power roller and the trunnion which supports the power roller at the neutral position and so as to fix a transmission ratio. In, for example, a state in which a drive of a pump, which is driven in association with a rotation of an output shaft of a drive source such as an engine stops, a hydraulic pressure of a working oil, which is supplied to a hydraulic pressure chamber to act a transmission shift control press force on the trunnion is reduced, and the transmission shift control press force does not act on the trunnion, when a vehicle on which the toroidal type continuously variable transmission is mounted is moved by that the vehicle is pulled, idly travels, and the like, there is a possibility that a transmission ratio is changed to a speed reducing side (speed increasing side) and a transmission ratio is shifted up because the output disc rotates, the tangential force acts on the power roller from the output disc, and the power roller moves to the transmission shift position. Therefore, when the vehicle starts and departs next, there is a possibility that the vehicle must start in a state in which the transmission ratio is relatively small with a result that there is a possibility that startability is deteriorated due to an insufficient amount of torque and the like. Accordingly, in the continuously variable transmission, it is desired to prevent an unintentional transmission shift in an operation state in which the transmission shift control press force cannot act on the trunnion.

In the operation state that the transmission shift control press force cannot act on the trunnion, it is also possible to prevent the unintentional transmission shift by reducing a press force generated by the press device (nip-press means) as in, for example, the continuously variable transmission in Patent Document 1 described above. However, since the continuously variable transmission described in Patent Document 1 does not specifically disclose a configuration that reduces the press force generated by the press device (nip-press means), there is desired a more appropriate prevention of the unintentional transmission shift, for example, a reduction of the press force generated by the press device (nip-press means) and an improvement of responsiveness of return of the press force.

Accordingly, an object of the present invention is to provide a continuously variable transmission which can appropriately prevent an unintentional transmission shift.

### Means for Solving Problem

In order to achieve the above mentioned object, a continuously variable transmission according to the present invention, includes an input disc to which a driving force is input; an output disc from which the driving force is output; a power roller interposed between the input disc and the output disc; a transmission ratio changing means that rotatably and tiltably supports the power roller as well as can change a transmission ratio as a rotation speed ratio of the input disc and the output disc by tiltably rotating the power roller; a nip-press means capable of applying a nip-pressure that nips the power roller between the input disc and the output disc by a pressure of a working medium supplied to a nip-pressure generation hydraulic chamber from a hydraulic pressure controlling means that controls the pressure of the working medium via a coupling oil passage; and a pressure release means that is disposed to the coupling oil passage and can release the pressure of the working medium of the nip-pressure generation hydraulic chamber via a release unit in response to an operation state, wherein the pressure release means is configured such that the release unit is positioned upward in a vertical direction of the nip-pressure generation hydraulic chamber in a state that the pressure release means is mounted on a vehicle.

Further, in the continuously variable transmission, it is preferred that when a drive source that generates the driving force is in a stop state, the pressure release means places a pressure of the working medium of the nip-pressure generation hydraulic chamber in a release state that the pressure is released via the release unit, whereas when the drive source is in a working state, the pressure release means places a pressure of the working medium of the nip-pressure generation hydraulic chamber in a shut-off state that a release of the pressure is shut off via the release unit.

Further, in the continuously variable transmission, it is preferred that when a drive source that generates the driving force is in a temporary stop state in an idling stop control in which an idling operation is automatically stopped, the pressure release means places a pressure of the working medium of the nip-pressure generation hydraulic chamber in a shut-off state that a release of the pressure is shut off via the release unit.

Further, in the continuously variable transmission, it is preferred that the pressure release means includes a branch release oil passage, where an end side of the branch release oil passage can communicate with the coupling oil passage as well as an opening of the other end side of the branch release oil passage acts as the release unit.

Further, in the continuously variable transmission, it is preferred that the pressure release means includes a switch means that can be switched to a close state that the nip-pressure generation hydraulic chamber is connected to the hydraulic pressure controlling means and to a release state that the nip-pressure generation hydraulic chamber is connected to the release unit.

Further, in the continuously variable transmission, it is preferred that the switch means is configured with an electromagnetic valve that is placed in the close state when energized, whereas placed in the release state when disenergized.

Further, in the continuously variable transmission, it is preferred that the switch means is positioned upward in the vertical direction of the nip-pressure generation hydraulic chamber in a state that the switch means is mounted on a vehicle.

Further, in the continuously variable transmission, it is preferred that the transmission ratio changing means acts a transmission shift control press force on a support means that supports the power roller by a pressure of the working medium to thereby move the power roller together with the support means from a neutral position with respect to the input disc and the output disc to a transmission shift position and tiltably rotate the power roller, the hydraulic pressure controlling means includes a pressurization means that can pressurize the working medium by being driven in association with a rotation of an output shaft of a drive source that generates the driving force, and when in an operation state that the transmission shift control press force cannot act on the support means, the pressure release means is placed in a release state that the pressure release means releases a pressure of the working medium of the nip-pressure generation hydraulic chamber via the release unit.

### Effect of the Invention

According to the continuously variable transmission of the present invention, since a pressure release means is disposed to a coupling oil passage and can release a pressure of a working medium of a nip-pressure generation hydraulic chamber via a release unit in response to an operation state and a release unit is positioned upward in a vertical direction of the nip-pressure generation hydraulic chamber in a state that the pressure release means is mounted on a vehicle, the continuously variable transmission can appropriately prevent an unintentional transmission shift.

### BRIEF DESCRIPTION OF DRAWINGS

FIG. 1 is a schematic sectional view of a toroidal type continuously variable transmission according to an embodiment of the present invention.

FIG. 2 is a schematic configuration view of a main portion of the toroidal type continuously variable transmission according to the embodiment of the present invention.

FIG. 3 is a schematic view explaining a neutral position to an input disc of a power roller provided with the toroidal type continuously variable transmission according to the embodiment of the present invention.

FIG. 4 is a schematic view explaining a transmission shift position to the input disc of the power roller provided with the toroidal type continuously variable transmission according to the embodiment of the present invention.

FIG. 5 is a schematic configuration view showing a working oil supply system to a nip-pressure generation hydraulic chamber of the toroidal type continuously variable transmission according to the embodiment of the present invention.

FIG. 6 is a schematic configuration view showing a working oil supply system to a nip-pressure generation hydraulic chamber of a toroidal type continuously variable transmission according to a modification of the present invention.

### EXPLANATION OF LETTERS OF NUMERALS

1 Toroidal type continuously variable transmission (continuously variable transmission)
2 Input disc
3 Output disc
4 Power roller
5 Transmission ratio changing unit (transmission ratio changing means)
6 Trunnion (support means)
7 Moving unit
8 Hydraulic piston unit
9 Hydraulic pressure controlling device (hydraulic pressure controlling means)
9a Oil pump (pressurization means)
10 Input shaft
11 Variator shaft
15 Hydraulic press mechanism (nip-press means)
15a Nip-pressure generating hydraulic chamber
15b Nip-pressure press force piston
15c Introduction/discharge port
21 Engine (drive source)
21a Crank shaft (output shaft of drive source)
100 Pressure release mechanism (pressure release means)
101 Coupling oil passage
101a Hydraulic chamber side oil passage
101b Control unit side oil passage
102 Release unit
103 Branch release oil passage
103a Release opening
104 Switch valve (switch means)
104a Solenoid
104b Elastic member
105 Reservoir

### BEST MODE(s) FOR CARRYING OUT THE INVENTION

An embodiment of a continuously variable transmission according to the present invention will be explained below based on the drawings in detail. Note that the present invention is by no means limited by the embodiment. Further, components in the embodiment include components which can be replaced by a person skilled in the art as well as which are easy and otherwise which include substantially the same components.

### Embodiment

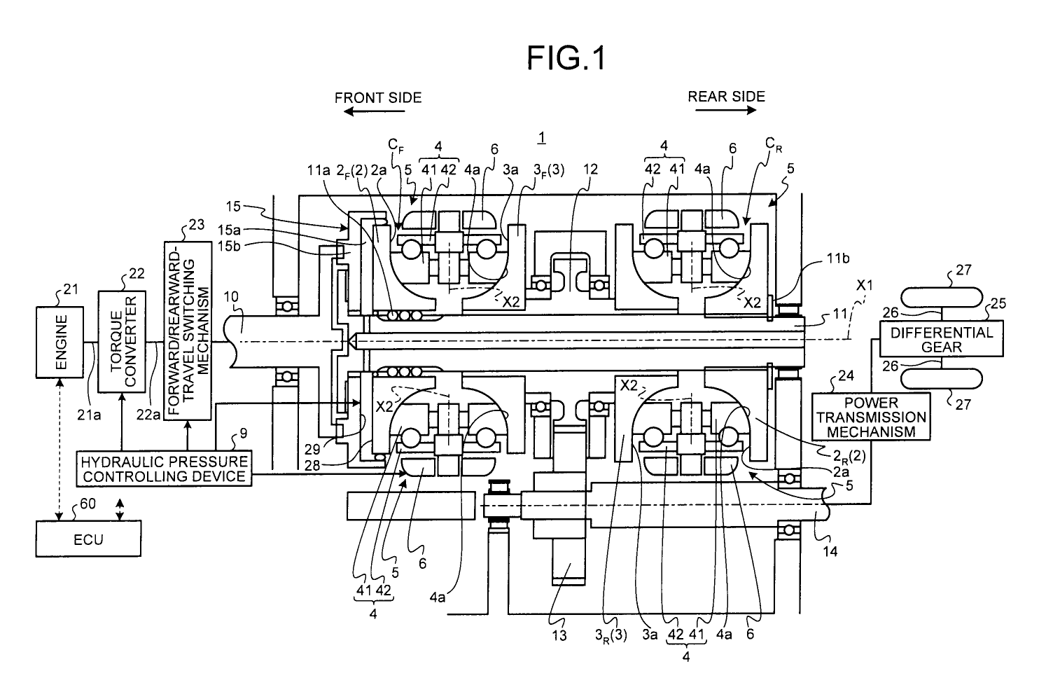

FIG. 1 is a schematic sectional view of a toroidal type continuously variable transmission according to an embodiment of the present invention,

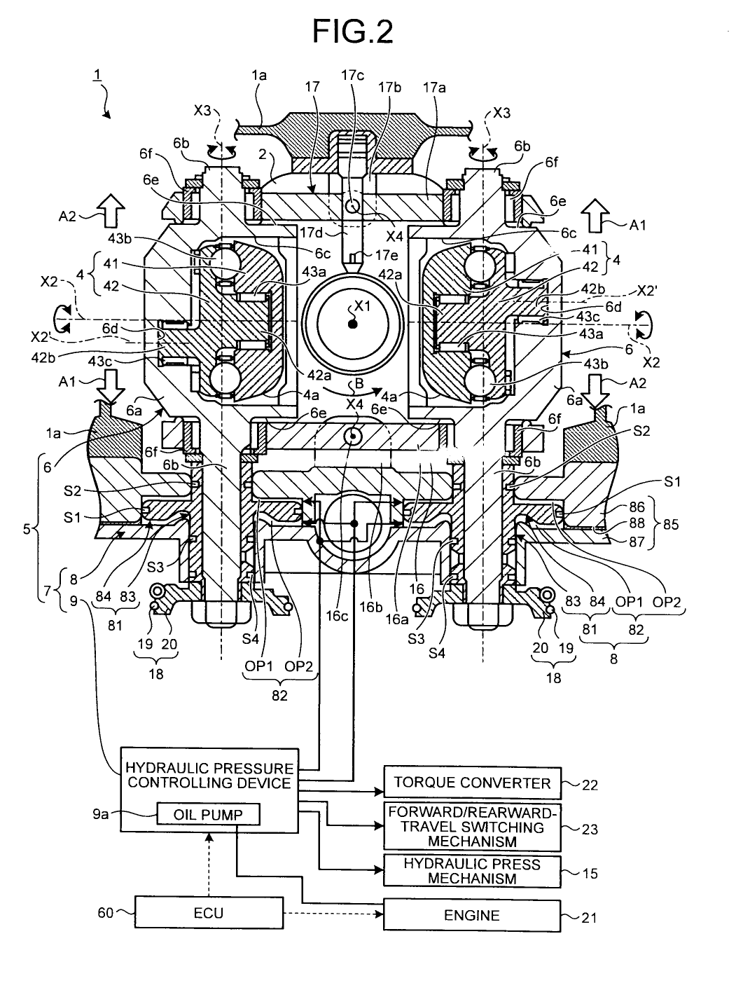

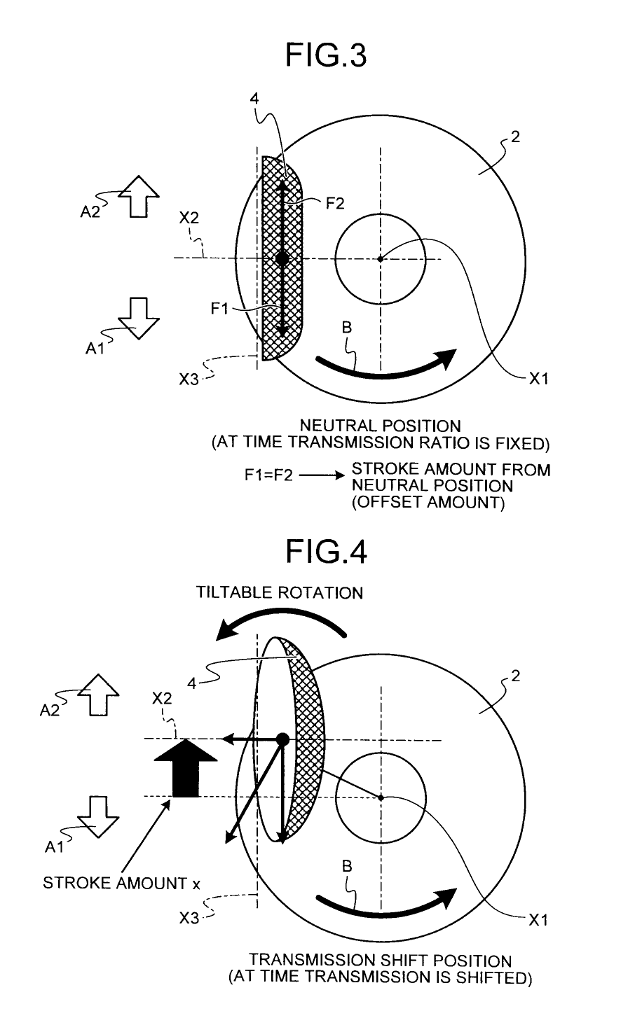

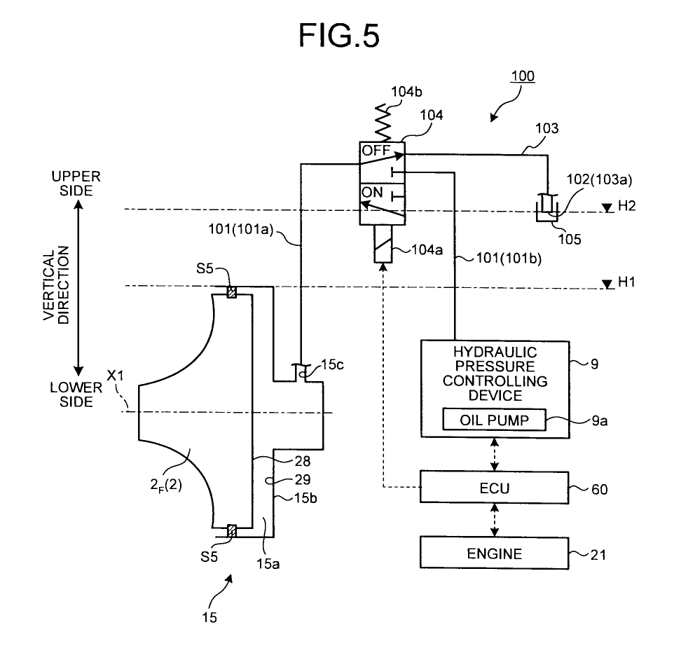

FIG. 2 is a schematic configuration view of a main portion of the toroidal type continuously variable transmission according to the embodiment of the present invention, FIG. 3 is a schematic view explaining a neutral position to an input disc of a power roller provided with the toroidal type continuously variable transmission according to the embodiment of the present invention, FIG. 4 is a schematic view explaining a transmission shift position to the input disc of the power roller provided with the toroidal type continuously variable transmission according to the embodiment of the present invention, and FIG. 5 is a schematic configuration view showing a working oil supply system to a nip-pressure generation hydraulic chamber of the toroidal type continuously variable transmission according to the embodiment of the present invention.

Note that FIG. 2 is a view showing an arbitrary power roller of respective power rollers which configure a toroidal type continuously variable transmission as a continuously variable transmission, and an input disc which is in contact with the power roller. Further, FIG. 3 and FIG. 4 are views showing input discs when viewed from output discs side and schematically show only one input disc and only one power roller, respectively.

In the embodiment explained below, although an internal combustion engine (gasoline engine, diesel engine, LPG engine, and the like) which generates engine torque is used as a drive source which generates a driving force transmitted to the continuously variable transmission of the present invention, the embodiment is not limited thereto and an electric motor such as a motor which generates motor torque may be used as the drive source. Further, the internal combustion engine may be used together with the motor as the drive source.

As shown in FIG. 1, a toroidal type continuously variable transmission 1 as the continuously variable transmission according to the embodiment transmits a driving force, that is, output torque from an engine 21 as the drive source mounted on a vehicle to drive wheels 27 in an optimum condition in response to a traveling state of the vehicle and is a so-called continuously variable transmission (CVT) which can control a transmission ratio non-stepwise (continuously). The toroidal type continuously variable transmission 1 is a so-called toroidal type continuously variable transmission which transmits torque between an input disc 2 and an output disc 3 via a power roller 4 nipped between the input disc 2 and the output disc 3 as well as changes a transmission ratio by tiltably rotating the power roller 4. More specifically, the toroidal type continuously variable transmission 1 nips the power roller 4, which has an outer peripheral surface formed in a curved surface corresponding to toroidal surfaces 2a, 3a, between the input disc 2 and the output disc 3 which have the toroidal surface 2a and the toroidal surface 3a, and transmits torque making use of a shear force of an oil film of a traction oil formed between the input disc 2, the output disc 3 and the power roller 4.

Specifically, as shown in FIG. 1 and FIG. 2, the toroidal type continuously variable transmission 1 includes the input disc 2, the output disc 3, the power roller 4, and a transmission ratio changing unit 5 as a transmission ratio changing means. The transmission ratio changing unit 5 includes a trunnion 6 as a support means and a moving unit 7. The moving unit 7 includes a hydraulic piston unit 8 and a hydraulic pressure controlling device 9 as a hydraulic pressure controlling means. Further, the toroidal type continuously variable transmission 1 includes an electronic control unit (ECU) 60 as a control means that controls respective units of the toroidal type continuously variable transmission 1. In the toroidal type continuously variable transmission 1, the power roller 4, which is disposed in contact with the input disc 2 and the output disc 3, is moved by the moving unit 7 from a neutral position to a transmission shift position with respect to the input disc 2 and the output disc 3, thereby the transmission ratio as a number of revolution ratio between the input disc 2 and the output disc 3 is changed.

The input disc 2 is transmitted (input) with the driving force (torque) from the engine 21 side via, for example, a torque converter 22, which is a departure mechanism and as a fluid transmission device, a forward/rearward-travel switching mechanism 23, and the like.

The engine 21 outputs engine torque, that is, the driving force which causes the vehicle, on which the engine 21 is mounted, to travel forward or rearward. Further, the engine 21 is electrically connected to the ECU 60, a drive of the engine 21 is controlled by the ECU 60, and the driving force output from the engine 21 is controlled by the ECU 60. The driving force from the engine 21 is transmitted to the torque converter 22 via a crank shaft 21a.

The torque converter 22 transmits the driving force from the engine 21 to the toroidal type continuously variable transmission 1 via the forward/rearward-travel switching mechanism 23. The torque converter 22 includes a pump (pump impeller), a turbine (turbine runner), a stator, and a lock up clutch. The pump is coupled with the crank shaft 21a of the engine 21 via a front cover and the like and disposed so as to rotate together with the crank shaft 21a and the front cover. The turbine is dispose to confront the pump. The turbine is coupled with an input shaft 10 via an input shaft 22a and the forward/rearward-travel switching mechanism 23 and disposed so as to be rotatable coaxially with the crank shaft 21a together with the input shaft 10. The stator is interposed between the pump and the turbine. The lock up clutch is interposed between the turbine and the front cover and coupled with the turbine.

Accordingly, in the torque converter 22, the driving force (engine torque) of the engine 21 is transmitted from the crank shaft 21a to the pump via the front cover. When the lock up clutch is released, the driving force, which is transmitted to the pump, is transmitted to the turbine, the input shaft 22a, and the input shaft 10 via a working oil as a working fluid interposed between the pump and the turbine. At the time, the torque converter 22 changes a flow of the working oil, which circulates between the pump and the turbine, via the stator and can obtain predetermined torque characteristics. In the torque converter 22, when the lock up clutch coupled with the turbine is engaged with the front cover, the driving force from the engine 21, which is transmitted to the pump via the front cover, is directly transmitted to the input shaft 10 without via the working oil. A control for engaging and disengaging the lock up clutch, that is, an ON/OFF control for turning ON and OFF the lock up clutch is performed by the working oil supplied from a hydraulic pressure controlling device 9 to be described later. The hydraulic pressure controlling device 9 is connected to the ECU 60 to be described later. Accordingly, the ON/OFF control of the lock up clutch is performed by the ECU 60.

The forward/rearward-travel switching mechanism 23 transmits the driving force from the engine 21, which is transmitted via the torque converter 22, to the input disc 2 of the toroidal type continuously variable transmission 1. The forward/rearward-travel switching mechanism 23 is configured of, for example, a planetary gear mechanism, a forward clutch (friction clutch), a reverse brake (friction brake), and the like and transmits the driving force of the engine 21 to the input disc 2 directly or after the driving force is reversed. That is, the driving force of the engine 21, which is transmitted via the forward/rearward-travel switching mechanism 23, is transmitted to the input disc 2 as a forward rotation driving force, which acts in a direction where the input disc 2 is rotated in a forward direction (in a direction where the input disc 2 is rotated when the vehicle travels forward) or as an reverse rotation driving force, which acts in a direction where the input disc 2 is rotated in a reverse rotation (in a direction where the input disc 2 is rotated when the vehicle travels backward). A switch control of a transmission direction of the driving force, which is performed by the forward/rearward-travel switching mechanism 23, is performed by engaging and disengaging the forward clutch and the reverse brake, that is, by performing an ON/OFF control for turning ON and OFF the forward clutch and the reverse brake. The switch control of the transmission direction of the driving force, which is performed by the forward/rearward-travel switching mechanism 23, in other words, the ON/OFF control of the forward clutch and the reverse brake, is performed by the working oil supplied from the hydraulic pressure controlling device 9 to be described later. Accordingly, the switch control of the forward/rearward-travel switching mechanism 23 is performed by the ECU 60.

Two input discs 2 are coupled with the input shaft 10 rotated based on the rotation of the engine 21 and disposed so that it can be rotated freely by the input shaft 10. More specifically, the input discs 2 are rotates by a variator shaft 11 which makes the same rotation as that of the input shaft 10. Accordingly, the input discs 2 can rotate about a rotation axis X1 of the input shaft 10 as a disc rotation axis. The toroidal type continuously variable transmission 1 is disposed with a front side input disc 2_{F} on a front side (the engine 21 side) to the variator shaft 11 and with a rear side input disc 2_{R} on a rear side (drive wheels 27 side) at a predetermined interval to the front side input disc 2_{F} in a direction along the rotation axis X1.

The front side input disc 2_{F} is supported by the variator shaft 11 via a ball spline 11a. That is, the front side input disc 2_{F} is supported by the variator shaft 11 so that it can rotate as the variator shaft 11 rotates as well as can move in a direction along to the rotation axis X1 to the variator shaft 11. Still more specifically, the front side input disc 2_{F} does not relatively rotate and offset about the rotation axis X1 to the variator shaft 11, whereas the front side input disc 2_{F} can relatively offset in the direction along the rotation axis X1. In contrast, the rear side input disc 2_{R} is supported by the variator shaft 11 via a spline engagement portion as well as a movement of the rear side input disc 2_{R} in the direction along the rotation axis X1 is restricted by a snap ring 11b disposed to a rear side end of the variator shaft 11. That is, the rear side input disc 2_{R} is supported by the variator shaft 11 so that it can rotate as the variator shaft 11 rotates as well as can move as the variator shaft 11 moves in the direction along the rotation axis X1 of the variator shaft 11. Still more specifically, the rear side input disc 2_{R} neither relatively rotates about the rotation axis X1 nor relatively offset also in the direction along the rotation axis X1 to the variator shaft 11. Note that, in the following explanation, when it is not necessary to particularly discriminate the front side input disc 2_{F} and the rear side input disc 2_{R}, they are simply abbreviated as “the input discs 2”.

Each of the input discs 2 has an opening formed at a center and a shape gradually projecting from an outside to a center side. A slant surface of the projecting portion of the input disc 2 is formed so that a cross section along the rotation axis X1 direction has an approximately arc shape so as to form a toroidal surface 2a of the input discs 2. The two input discs 2 are disposed so that the toroidal surfaces 2a confront each other.

The output disc 3 transmits (outputs) the driving force transmitted (input) to the input discs 2 to the drive wheels 27 side, and one output disc 3 is disposed corresponding to each of the input discs 2, that is, two output discs 3 are disposed in total. In the toroidal type continuously variable transmission 1, a front side output disc 3_{F} is disposed on the front side (the engine 21 side) and a rear side output disc 3_{R} is disposed on the rear side (the drive wheels 27 side) to the variator shaft 11. The front side output disc 3_{F} and the rear side output disc 3_{R} are disposed together between the front side input disc 2_{F} and the rear side input disc 2_{R} to the direction along the rotation axis X1, and, more specifically the rear side output disc 3_{R} is interposed between the front side output disc 3_{F} and the rear side input disc 2_{R}. That is, the toroidal type continuously variable transmission 1 is disposed sequentially with the front side input disc 2_{F}, the front side output disc 3_{F}, the rear side output disc 3_{R}, and the rear side input disc 2_{R} from the front side to the direction along the rotation axis X1. Note that, in the following explanation, when it is not necessary to particularly discriminate the front side output disc 3_{F} and the rear side output disc 3_{R}, they are simply abbreviated as “the output discs 3”.

The input discs 2 and the output discs 3 are disposed so as to rotate freely relatively to the input shaft 10 coaxially with the rotation axis X1. Accordingly, the output discs 3 can rotate about the rotation axis X1. The output discs 3 are formed in an approximately similar shape as the input discs 2, that is, each of the output discs 3 has an opening formed at a center and a shape gradually projecting from an outside to a center side. A slant surface of the projecting portion of each output disc 3 is formed so that a cross section along the rotation axis X1 direction has an approximately arc shape so as to form a toroidal surface 3a of the output discs 3. As described above, the output discs 3 are interposed between the two input discs 2 to the direction along the rotation axis X1 as described above as well as the toroidal surfaces 3a are disposed to confront the toroidal surfaces 2a of the input discs 2, respectively. That is, in a cross section along the rotation axis X1, the toroidal surface 2a of the front side input disc 2_{F} on one side confronts the toroidal surface 3a of the front side output disc 3_{F} to thereby form a front side (the engine 21 side) semicircular cavity C_{F}, and the toroidal surface 2a of the other rear side input disc 2_{R} confront the toroidal surface 3a of the rear side output disc 3_{R} to thereby form the other rear side (the drive wheels 27 side) semicircular cavity C_{R}.

Further, the output discs 3 are rotatably supported by the variator shaft 11 via bearings. An output gear 12 is coupled between the two output discs 3, and the output gear 12 can rotate integrally with the two output discs 3. The output gear 12 is meshed with a counter gear 13 which is coupled with an output shaft 14. Accordingly, as the output discs 3 rotate, the output shaft 14 is rotated. The output shaft 14 is connected to the drive wheels 27 via a power transmission mechanism 24, a differential gear 25, and the like, and the driving force is transmitted (output) to the drive wheels 27 via the power transmission mechanism 24, the differential gear 25, and the like.

The power transmission mechanism 24 transmits the driving force between the toroidal type continuously variable transmission 1 and the differential gear 25. The power transmission mechanism 24 is interposed between the output disc 3 and the differential gear 25. The differential gear 25 transmits the driving force between the power transmission mechanism 24 and the drive wheels 27. The differential gear 25 is interposed between the power transmission mechanism 24 and the drive wheels 27. The differential gear 25 is coupled with a drive shaft 26. The drive shaft 26 is attached with the drive wheels 27.

The power roller 4 is interposed between the input disc 2 and the output discs 3 in contact with the input disc 2 and the output discs 3 and transmits the driving force from the input disc 2 to the output disc 3. That is, the power roller 4 has outer peripheral surfaces formed as a curved contact surface 4a corresponding to the toroidal surfaces 2a, 3a. The power roller 4 is nipped between the input disc 2 and the output disc 3, and the contact surface 4a can come into contact with the toroidal surfaces 2a, 3a. Respective power rollers 4 are rotatably supported by the trunnion 6 to be described later about a rotation axis X2 as a power roller rotation axis with the contact surfaces 4a in contact with the toroidal surfaces 2a, 3a, respectively. The power roller 4 transmits the driving force (torque) using the shear force of the oil film which is formed between the toroidal surfaces 2a, 3a of the input disc 2 and the output disc 3 and the contact surfaces 4a of the power roller 4 by the traction oil supplied to the toroidal type continuously variable transmission 1.

Two power rollers 4 are disposed to one cavity formed of a pair of the input disc 2 and the output disc 3, respectively, that is, four power rollers 4 are disposed in total. That is, the toroidal type continuously variable transmission 1 is disposed with a pair of two power rollers 4 to the front side semicircular cavity C_{F} and a pair of two power rollers 4 to the rear side semicircular cavity C_{R}. The pair of power rollers 4, which are disposed to the front side semicircular cavity C_{F}, and the pair of power rollers 4, which are disposed to the rear side semicircular cavity C_{R}, are disposed in confrontation with each other across the rotation axis X1.

More specifically, each of the power roller 4 is configured of a power roller main body 41 and an outer ring 42. An outer peripheral surface of the power roller main body 41 is formed with the contact surface 4a described above which is in contact with the toroidal surfaces 2a, 3a of the input disc 2 and the output disc 3. The power roller main body 41 is rotatably supported to a rotating shaft 42a formed to the outer ring 42 via a bearing unit (radial bearing) 43a. Further, the power roller main body 41 is rotatably supported to a surface confronting the power roller main body 41 of the outer ring 42 via a bearing unit (thrust bearing) 43b. Accordingly, the power roller main body 41 can rotate about the rotation axis X2 of the rotating shaft 42a.

The outer ring 42 is formed with an eccentric shaft 42b together with the rotating shaft 42a described above. The eccentric shaft 42b is formed so that a rotation axis X2′ is located at a position offset to the rotation axis X2 of the rotating shaft 42a. The eccentric shaft 42b is rotatably supported to an engagement portion 6d formed as a concave portion to a roller support portion 6a of the trunnion 6 to be described later via a bearing unit (radial bearing) 43c. Accordingly, the outer ring 42 can rotate about the rotation axis X2′ of the eccentric shaft 42b. That is, the power roller 4 can rotate about the rotation axis X2 and the rotation axis X2′ to the trunnion 6, that is, the power roller 4 can revolute about the rotation axis X2′ as well as can rotate about the rotation axis X2. With the configuration, the power roller 4 are configured to be able to move in the direction along the rotation axis X1 and can allow, for example, a deformation of parts and a dispersion accuracy of parts.

The input shaft 10 is connected to a hydraulic press (end load) mechanism 15 as a nip-press means. The hydraulic press mechanism 15 applies a nip-pressure which causes the input disc 2 and the output disc 3 to come into contact with the power roller 4 and nips the power roller 4 between the input disc 2 and the output disc 3. The hydraulic press mechanism 15 includes a nip-pressure generation hydraulic chamber 15a and a nip-pressure press force piston 15b. The hydraulic press mechanism 15 acts a pressure of the working oil as the working medium which is supplied to the nip-pressure generation hydraulic chamber 15a, that is, a hydraulic pressure on a front side input disc nip-pressure press force application surface 28 and a rear side input disc nip-pressure press force application surface 29 as pressure application surfaces which rotate as the input disc 2 rotate, thereby acting a nip-pressure which nips the power roller 4 between the input disc 2 and the output disc 3.

Specifically, the nip-pressure generation hydraulic chamber 15a is disposed on one side in a direction along the rotation axis X1 with respect to the two input discs 2. Here, the nip-pressure generation hydraulic chamber 15a is disposed on the front side input disc 2_{F} side to the direction along the rotation axis X1 and interposed between the input shaft 10 and the front side input disc 2_{F}. The working oil is supplied into the nip-pressure generation hydraulic chamber 15a from the hydraulic pressure controlling device 9 in response to an operation state.

The nip-pressure press force piston 15b is formed in a disc shape and disposed to an end portion of the variator shaft 11 so that a center of the nip-pressure press force piston 15b approximately agrees with the rotation axis X1. The nip-pressure press force piston 15b is disposed to an end portion of the variator shaft 11 opposite to an end portion thereof to which the rear side input disc 2_{R} is disposed, that is, disposed to the front side (the engine 21 side). The nip-pressure press force piston 15b is interposed between the input shaft 10 and the front side input disc 2_{F} to the direction along the rotation axis X1 at an interval to the front side input disc 2_{F}. The nip-pressure generation hydraulic chamber 15a described above is interposed between the nip-pressure press force piston 15b and the front side input disc 2_{F}.

Further, the nip-pressure press force piston 15b can rotate together with the variator shaft 11 about the rotation axis X1 to the variator shaft 11 and is disposed so as to move in the direction along the rotation axis X1. That is, the nip-pressure press force piston 15b is supported by the variator shaft 11 so that it can rotate as the variator shaft 11 rotates as well as can move as the variator shaft 11 moves in the direction along the rotation axis X1. Still more specifically, the nip-pressure press force piston 15b neither relatively rotates about the rotation axis X1 nor relatively offsets also in the direction along the rotation axis X1 to the variator shaft 11. Accordingly, the rear side input disc 2_{R}, the variator shaft 11, and the nip-pressure press force piston 15b can rotate integrally about the rotation axis X1 and can move in the direction along the rotation axis X1. Further, the front side input disc 2_{F} can rotate about the rotation axis X1 integrally with the rear side input disc 2_{R}, the variator shaft 11, and the nip-pressure press force piston 15b as well as can be relatively moved by a ball spline 11a in the direction along the rotation axis X1 to the rear side input disc 2_{R}, the variator shaft 11, and the nip-pressure press force piston 15b.

Further, the nip-pressure press force piston 15b is coupled also with the input shaft 10, can rotates about the rotation axis X1 together with the input shaft 10, and is disposed so that it can relatively move in the direction along the rotation axis X1. That is, the rear side input disc 2_{R}, the variator shaft 11, and the nip-pressure press force piston 15b can rotate about the rotation axis X1 integrally with the input shaft 10, whereas the rear side input disc 2_{R}, the variator shaft 11, and the nip-pressure press force piston 15b can relatively move in the direction along the rotation axis X1 to the input shaft 10. The driving force from the input shaft 10 is transmitted to the variator shaft 11 and transmitted from the variator shaft 11 to the front side input disc 2_{F} and the rear side input disc 2_{R}.

Further, the front side input disc 2_{F} has the front side input disc nip-pressure press force application surface 28 described above, whereas the nip-pressure press force piston 15b has the rear side input disc nip-pressure press force application surface 29 described above. The front side input disc nip-pressure press force application surface 28 is disposed on a back surface of the toroidal surface 2a as a contact surface with the power roller 4 in the front side input disc 2_{F}. The rear side input disc nip-pressure press force application surface 29 is disposed on a surface which confronts the front side input disc nip-pressure press force application surface 28 in the direction along the rotation axis X1 in the nip-pressure press force piston 15b. The rear side input disc nip-pressure press force application surface 29 is disposed to confront the front side input disc nip-pressure press force application surface 28 across the nip-pressure generation hydraulic chamber 15a described above. The nip-pressure generation hydraulic chamber 15a is partitioned by the front side input disc nip-pressure press force application surface 28 and the rear side input disc nip-pressure press force application surface 29 between the nip-pressure press force piston 15b and the front side input disc 2_{F} to the direction along the rotation axis X1. That is, the front side input disc nip-pressure press force application surface 28 and the rear side input disc nip-pressure press force application surface 29 are configured such that the front side input disc nip-pressure press force application surface 28 confronts the nip-pressure generation hydraulic chamber 15a on a rear side, and the rear side input disc nip-pressure press force application surface 29 confronts the nip-pressure generation hydraulic chamber 15a on a front side.

Accordingly, the hydraulic press mechanism 15 acts a nip-pressure press force on the front side input disc nip-pressure press force application surface 28 and the rear side input disc nip-pressure press force application surface 29 by the hydraulic pressure of the working oil supplied into the nip-pressure generation hydraulic chamber 15a so as to move the front side input disc 2_{F} in a direction where the front side input disc 2_{F} is separated from the hydraulic press mechanism 15 side to the rear side and to move the rear side input disc 2_{R} in a direction where the rear side input disc 2_{R} approaches the hydraulic press mechanism 15 side from the rear side together with the variator shaft 11. At the time, the front side input disc 2_{F} relatively moves in the direction along the rotation axis X1 with respect to the variator shaft 11. The hydraulic press mechanism 15 moves the front side input disc 2_{F} from the hydraulic press mechanism 15 side to the rear side and moves the rear side input disc 2_{R} in the direction where the rear side input disc 2_{R} approaches the front side together with the variator shaft 11 so that the front side input disc 2_{F} is approached to the front side output disc 3_{F} as well as the rear side input disc 2_{R} is approached to the rear side output disc 3_{R}, thereby generating a nip-pressure between the front side input disc 2_{F} and the front side output disc 3_{F} and between the rear side input disc 2_{R} and the rear side output disc 3_{R}. With the operation, since the hydraulic press mechanism 15 generates the nip-pressure between the front side input disc 2_{F} and the front side output disc 3_{F} and between the rear side input disc 2_{R} and the rear side output disc 3_{R}, the hydraulic press mechanism 15 can nip the power roller 4 between the front side input disc 2_{F} and the front side output disc 3_{F} and between the rear side input disc 2_{R} and the rear side output disc 3_{R} by a predetermined nip-pressure, respectively. As a result, a slip between the input discs 2, the output discs 3 and the power roller 4 can be prevented and an appropriate traction state can be kept.

The nip-pressure press force created by the hydraulic press mechanism 15, in other words, a nip-pressure, is controlled to a predetermined magnitude based on the input torque to the toroidal type continuously variable transmission 1 by that an amount or a hydraulic pressure of the working oil, which is supplied to the nip-pressure generation hydraulic chamber 15a, is controlled by the hydraulic pressure controlling device 9 to be described later. The hydraulic pressure controlling device 9 is connected to the ECU 60 to be described later. Accordingly, the magnitude of the nip-pressure press force created by the hydraulic press mechanism 15 is controlled by the ECU 60.

As described above, the transmission ratio changing unit 5 includes the trunnion 6 and the moving unit 7, moves the power roller 4 together with the trunnion 6 by the moving unit 7 to the rotation axis X1 of the input disc 2 and the output disc 3, and changes a transmission ratio by tiltably rotating the power roller 4 with respect to the input disc 2 and the output disc 3. The transmission ratio is a rotation speed ratio between the input disc 2 and the output disc 3, in other words, the number of revolution ratio and can be typically shown by [transmission ratio=output side contact radius (contact radius at which power roller 4 is in contact with output disc 3 (distance between contact point and rotation axis X1))/input side contact radius (contact radius at which input disc 2 is in contact with power roller 4)].

Specifically, respective trunnions 6 rotatably support the power roller 4, respectively as well as move the power roller 4 with respect to the input disc 2 and the output disc 3 to thereby tiltably support the power roller 4 with respect to the input disc 2 and the output disc 3. The trunnion 6 includes the roller support portion 6a and a rotating shaft 6b as a shaft portion.

The roller support portion 6a is formed with a space portion 6c in which the power roller 4 is disposed, and the space portion 6c is formed with the concave engagement portion 6d. Then, the trunnion 6 rotatably supports the power roller 4 by that the eccentric shaft 42b of the power roller 4 is inserted into the engagement portion 6d in the space portion 6c as described above. Further, the roller support portion 6a is disposed so that it can move integrally with the rotating shaft 6b. The rotating shaft 6b is formed so as to project from a shoulder portion 6e of the roller support portion 6a.

The shoulder portion 6e of the roller support portion 6a is a wall surface portion which is disposed so as to stand with respect to a wall surface portion where the engagement portion 6d is disposed in the roller support portion 6a. A pair of shoulder portions 6e are disposed on the wall surface portion where the engagement portion 6d is disposed in the roller support portion 6a, and the pair of shoulder portions 6e are disposed to confront each other. The roller support portion 6a is formed with the space portion 6c described above by that the pair of shoulder portions 6e confront each other. In the roller support portion 6a, the wall surface portion, to which the engagement portion 6d is disposed, and the pair of shoulder portions 6e are formed integrally.

The rotating shaft 6b is formed to project from the pair of shoulder portions 6e the roller support portion 6a as described above, respectively. Respective rotating shafts 6b are formed in a columnar shape and disposed rotatably about rotation axis X3 which are coaxial with each other. The trunnion 6 is supported by a casing 1a via a lower link 16a, an upper link 17a, a cylinder body 86, and the like to be described later so that the roller support portion 6a can rotate about a rotation axis X3 together with the rotating shaft 6b. Further, the trunnion 6 is supported by the casing 1a via the lower link 16a, the upper link 17a, the cylinder body 86, and the like so that the roller support portion 6a can move in a direction along the rotation axis X3 together with the rotating shaft 6b and configured so as to be moved by the moving unit 7 to be described later in the direction along the rotation axis X3.

Note that the lower link 16a and the upper link 17a will be explained later in detail.

Two trunnions 6 are disposed to one cavity formed of the pair of the input disc 2 and an output disc 3 respectively, that is, fourth trunnions are disposed in total and support the four power rollers 4 one by one, respectively. More specifically, the toroidal type continuously variable transmission 1 is disposed with a pair of two trunnions 6 which support two power rollers 4 to the front side semicircular cavity C_{F}, respectively and with a pair of two trunnions 6 which support two power rollers 4 to the rear side semicircular cavity C_{R}, respectively.

The trunnion 6 supports the power roller 4 so that the rotation axis X2 of the power roller 4 is in parallel with a plane vertical to the rotation axis X3 of the rotating shaft 6b. Further, the trunnion 6 is disposed so that the rotation axis X3 of the rotating shaft 6b is in parallel with a plane vertical to the rotation axis X1 of the input disc 2 and the output disc 3. That is, since the trunnion 6 moves along the rotation axis X3 in the plane vertical to the rotation axis X1, the trunnion 6 can move the power roller 4 along the rotation axis X3 to the rotation axis X1 of the input disc 2 and the output disc 3. Further, the trunnion 6 rotates about the rotation axis X3, the trunnion 6 can tiltably rotate the power roller 4 to the input disc 2 and the output disc 3 about the rotation axis X3 in the plane vertical to the rotation axis X3. Note that, in other words, the trunnion 6 tiltably supports the power roller 4 by that a tiltable rotation force to be described later acts on the power roller 4.

The moving unit 7 moves the power roller 4 together with the trunnion 6 in the direction along the rotation axis X3, and includes the hydraulic piston unit 8 and the hydraulic pressure controlling device 9 as described above.

The hydraulic piston unit 8 is configured including a transmission shift control piston 81 as a piston and a transmission shift control hydraulic pressure chamber 82 and moves the trunnions 6 in two directions (A1 direction and A2 direction) along the rotation axis X3 by receiving the hydraulic pressure of the working oil introduced into the transmission shift control hydraulic pressure chamber 82 by a flange portion 84 of the transmission shift control piston 81. That is, the hydraulic piston unit 8 acts the transmission shift control press force on the flange portion 84 disposed to the trunnion 6 by the hydraulic pressure of the working oil supplied to the transmission shift control hydraulic pressure chamber 82.

Specifically, the transmission shift control piston 81 is configured of a piston base 83 and the flange portion 84. The piston base 83 is inserted with an end portion of the rotating shaft 6b formed in a cylindrical shape and fixed to a direction of the rotation axis X3 and to a direction about the rotation axis X3.

The flange portion 84 is fixedly disposed so as to project from the piston base 83 in a radial direction of the piston base 83, in other words, in a radial direction of the rotating shaft 6b and can move in a direction along the rotation axis X3 together with the piston base 83 and the rotating shaft 6b of the trunnion 6. The flange portion 84 is formed in an annular ring sheet shape about the rotation axis X3 of each rotating shaft 6b.

The transmission shift control hydraulic pressure chamber 82 is formed of a hydraulic pressure chamber forming member 85. The hydraulic pressure chamber forming member 85 is configured of the cylinder body 86 as a first forming member and a lower cover 87 as a second forming member. More specifically, the hydraulic pressure chamber forming member 85 acts as a wall surface of the transmission shift control hydraulic pressure chamber 82 as well as is divided to the cylinder body 86 and the lower cover 87 in the direction along the rotation axis X3 which is a moving direction (stroke direction) of the trunnion 6. The cylinder body 86 is formed with a concave portion acting as a space portion of the transmission shift control hydraulic pressure chamber 82. The lower cover 87 is fixed to the cylinder body 86 so as to close an opening of the concave portion of the cylinder body 86 to thereby partition the transmission shift control hydraulic pressure chamber 82 to a cylindrical (cylindrical) shape about the rotation axis X3 by the cylinder body 86 and the lower cover 87. The cylinder body 86 and the lower cover 87 are fixed to the casing 1a on a side opposite to the lower cover 87 side of the cylinder body 86. Note that a gasket 88, which prevents a leakage of the working oil in the transmission shift control hydraulic pressure chamber 82 to the outside, is interposed between the cylinder body 86 and the lower cover 87.

The flange portion 84 is accommodated in the transmission shift control hydraulic pressure chamber 82 into which the working oil is introduced as well as an interior of the transmission shift control hydraulic pressure chamber 82 is partitioned to two hydraulic pressure chambers, that is, to a first hydraulic pressure chamber OP1 and a second hydraulic pressure chamber OP2 in the direction along the rotation axis X3. The first hydraulic pressure chamber OP1 moves the trunnion 6 together with the flange portion 84 in the first direction A1 along the rotation axis X3 by the hydraulic pressure of the working oil supplied into the first hydraulic pressure chamber OP1, whereas the second hydraulic pressure chamber OP2 moves the trunnion 6 together with the flange portion 84 in the second direction A2 as a direction opposite to the first direction by the hydraulic pressure of the working oil supplied into the second hydraulic pressure chamber OP2.

An annular seal member S1 is disposed to an outside extreme end of the flange portion 84 in a radial direction, and thus the first hydraulic pressure chamber OP1 and the second hydraulic pressure chamber OP2 of the transmission shift control hydraulic pressure chamber 82, which is partitioned by the flange portion 84, are sealed by the seal member S1, respectively so that the working oil does not leak therefrom. Further, annular seal members S2, S3, S4 are interposed between an outer peripheral portion of the piston base 83 and the cylinder body 86 and the lower cover 87, which are the hydraulic pressure chamber forming member 85 that forms the transmission shift control hydraulic pressure chamber 82, and thus a portion between the outer peripheral portion of the piston base 83 and the cylinder body 86 and the lower cover 87 is sealed by the seal members S2, S3, S4 so that the working oil in the transmission shift control hydraulic pressure chamber 82 does not leak to the outside.

Note that since the two power rollers 4 and the two trunnions 6 are disposed to each pair of input disc 2 and output disc 3, two first hydraulic pressure chambers OP1 and two second hydraulic pressure chambers OP2 are disposed to each pair of input disc 2 and output disc 3. In the pair of trunnions 6, a positional relation between the first hydraulic pressure chamber OP1 and the second hydraulic pressure chamber OP2 changes in each trunnion 6. That is, a hydraulic pressure chamber acting as the first hydraulic pressure chamber OP1 of one trunnion 6 becomes the second hydraulic pressure chamber OP2 of the other trunnion 6, and a hydraulic pressure chamber acting as the second hydraulic pressure chamber OP2 of the one trunnion 6 becomes the first hydraulic pressure chamber OP1 of the other trunnion 6. Accordingly, in the toroidal type continuously variable transmission 1 shown in FIG. 2, the two power rollers 4, which are disposed to each pair of input disc 2 and output disc 3 is move in a reverse direction from each other along the rotation axis X3 by a hydraulic pressure in the first hydraulic pressure chamber OP1 or in the second hydraulic pressure chamber OP2.

The hydraulic pressure controlling device 9 supplies the working oil to respective portions of the transmission, for example, to the transmission shift control hydraulic pressure chamber 82 of the hydraulic piston unit 8, the nip-pressure generation hydraulic chamber 15a of the hydraulic press mechanism 15, the torque converter 22, the forward/rearward-travel switching mechanism 23, and the like. The hydraulic pressure controlling device 9 controls the amount or the hydraulic pressure of the working oil supplied to at least the nip-pressure generation hydraulic chamber 15a and the transmission shift control hydraulic pressure chamber 82.

The hydraulic pressure controlling device 9 sucks, pressurizes, and ejects the working oil, which is stored in an oil tank and supplied to the respective portions of the transmission, by an oil pump 9a as a pressurization means. The oil pump 9a is driven in association with, for example, a rotation of the crank shaft 21a as an output shaft of the engine 21 which generates the driving force and sucks, pressurizes, and ejects the working oil stored in the oil tank.

The hydraulic pressure controlling device 9 supplies the working oil pressurized by the oil pump 9a to various flow rate control valves and the like via a pressure regulator valve. The various flow rate control valves are configured including a spool valve element, an electromagnetic solenoid, and the like, and includes a flow rate control valve, which controls a supply of the working oil to the first hydraulic pressure chamber OP1 and the second hydraulic pressure chamber OP2 or a discharge of the working oil from the first hydraulic pressure chamber OP1 and the second hydraulic pressure chamber OP2, a flow rate control valve, which controls a supply of the working oil to the nip-pressure generation hydraulic chamber 15a or a discharge of the working oil from the nip-pressure generation hydraulic chamber 15a, and the like. In the flow rate control valves of the hydraulic pressure controlling device 9, an electromagnetic solenoid, which is driven by a drive current based on a control command value input from for example, the ECU 60, changes a position of the spool valve element, thereby controlling the flow rate or the hydraulic pressure of the working oil supplied to or discharged from the first hydraulic pressure chamber OP1, the second hydraulic pressure chamber OP2, and the nip-pressure generation hydraulic chamber 15a. Note that, when a hydraulic pressure downstream of the pressure regulator valve becomes a predetermined hydraulic pressure or more, that is, becomes a line pressure, which is used as an original pressure of the hydraulic pressure controlling device 9, or more, the pressure regulator valve returns the working oil on the downstream side to the oil tank adjusts the hydraulic pressure thereof to the predetermined line pressure.

For example, when the ECU 60 controls the flow rate control valves of the hydraulic pressure controlling device 9, supplies the working oil pressurized by the oil pump 9a to the first hydraulic pressure chamber OP1, and discharges the working oil in the second hydraulic pressure chamber OP2, the hydraulic pressure in the first hydraulic pressure chamber OP1 acts on the flange portion 84 so that [hydraulic pressure of first hydraulic pressure chamber OP1>hydraulic pressure of second hydraulic pressure chamber OP2] is established. With the operation, the flange portion 84 of the hydraulic piston unit 8 is pressed in the first direction A1 along the rotation axis X3, and the power roller 4 moves in the first direction A1 along the rotation axis X3 together with the trunnion 6. Likewise, when the ECU 60 controls the flow rate control valves of the hydraulic pressure controlling device 9, discharges the working oil pressurized by the oil pump 9a from first hydraulic pressure chamber OP1, and supplies the working oil into the second hydraulic pressure chamber OP2, the hydraulic pressure in the second hydraulic pressure chamber OP2 acts on the flange portion 84 so that [hydraulic pressure of first hydraulic pressure chamber OP1<hydraulic pressure of second hydraulic pressure chamber OP2] is established. With the operation, the flange portion 84 of the hydraulic piston unit 8 is pressed in the second direction A2 along the rotation axis X3, and the power roller 4 moves in the second direction A2 along the rotation axis X3 together with the trunnion 6. At the time, the movement of the power roller 4 in the first direction A1 or the second direction A2 is adjusted in response to the moving amounts of the spool valve elements of the flow rate control valves

Accordingly, in the moving unit 7, when the hydraulic pressure controlling device 9 is driven by the ECU 60 and hydraulic pressures in the respective transmission shift control hydraulic pressure chambers 82 of the hydraulic piston unit 8 are controlled, since a predetermined transmission shift control press force is applied to the flange portion 84 of the transmission shift control piston 81, the power roller 4 can be moved together with the trunnion 6 in the two directions along the rotation axis X3, that is, in the first direction A1 and the second direction A2. At the time, as described above, the pair of trunnions 6 and the pair of power rollers 4 disposed to each pair of input disc 2 and output disc 3 move in the reverse direction from each other along the rotation axis X3. The transmission ratio changing unit 5 can change the transmission ratio by that the moving unit 7 moves the pair of power rollers 4 together with the pair of trunnions 6 from the neutral position (refer to FIG. 3) to the input disc 2 and the output disc 3 to the transmission shift position (refer to FIG. 4) in response to the transmission ratio in the reverse direction from each other and tiltably rotates the power roller 4 to the input disc 2 and the output disc 3.

As shown in FIG. 3, the neutral position of the power roller 4 to the input disc 2 and the output disc 3 is a position where the transmission ratio is fixed and is a position where a tiltable rotation force, which tiltably rotates the power roller 4 to the input disc 2 and the output disc 3, cannot act on the power roller 4. More specifically, in a state that the power roller 4 is placed at the neutral position and the transmission ratio is fixed, the rotation axis X2 of the power roller 4 is set in a plane which includes the rotation axis X1 as well as is vertical to the rotation axis X3. In other words, at the neutral position of the power roller 4 (when the transmission ratio is fixed), the position of the power roller 4 in the direction along the rotation axis X3 is set to a position where the rotation axis X2 of the power roller 4 passes through (is orthogonal to) the rotation axis X1. At the time, at contact points of the power roller 4 and the input disc 2, the output disc 3, a rotation direction (rolling direction) of the power roller 4 agrees with a rotation direction of the input disc 2 and the output disc 3. As a result, the tiltable rotation force does not act on the power roller 4 and thus the power roller 4 continuously rotates together with the input disc 2 while staying at the neutral position, and the transmission ratio is fixed in the period.

At the time, since a force, which acts from the input disc 2 to the power roller 4, is basically only the driving force (torque), the hydraulic piston unit 8 and the hydraulic pressure controlling device 9 of the moving unit 7 act a force, which is large enough to resist the driving force, on the trunnion 6 by a hydraulic pressure. More specifically, when the power roller 4 and the trunnion 6 which supports the power roller 4 are at the neutral position, as described above, a transmission shift control press force F2 (refer to FIG. 3), which is large enough to resist a tangential force F1 (refer to FIG. 3) acting on the contact points of the input disc 2, the output disc 3 and the power roller 4, is applied to the flange portion 84 in response to the input torque and the tangential force F1, which acts on the power roller 4, is balanced with the transmission shift control press force F2 to thereby fix the positions of the power roller 4 and the trunnion 6 which supports the power roller 4 to the neutral position and fix the transmission ratio.

In contrast, as shown in FIG. 4, a transmission shift position of the power roller 4 is a position where the transmission ratio is changed and is a position where the tiltable rotation force, which tiltably rotates the power roller 4 to the input disc 2 and the output disc 3, acts on the power roller 4. More specifically, in a state that the power roller 4 is placed at the transmission shift position and the transmission ratio is changed, the rotation axis X2 of the power roller 4 is set to a position which is moved in the first direction A1 or the second direction A2 along the rotation axis X3 from the plane which includes the rotation axis X1 as well as is vertical to the rotation axis X3. In other words, at the transmission shift position of the power roller 4 (when the transmission is shifted), the position of the power roller 4 in the direction along the rotation axis X3 is set to a position where the rotation axis X2 of the power roller 4 passes through the rotation axis X1, that is, to a position offset from the neutral position. At the time, at the contact points of the power roller 4 and the input disc 2, the output disc 3, a rotation direction of the power roller 4 is offset from a rotation direction of the input disc 2 and the output disc 3 so that the tiltable rotation force acts on the power roller 4. As a result, a side slip is generated between the power roller 4 and the input disc 2 and the output disc 3 by the tiltable rotation force that acts on the power roller 4, the power roller 4 tiltably rotates to the input disc 2 and the output disc 3, and an input side contact radius of the power roller 4 and the input disc 2 and an output side contact radius of the power roller 4 and the output disc 3 are changed, and thus the transmission ratio is changed.

For example, as shown in FIG. 4, in a state that the input disc 2 rotates in an arrow B direction (counterclockwise) in FIG. 4, the power roller 4 is offset in the second direction A2 along the rotation axis X3 (a direction against to a moving direction of the input disc 2 at the contact point of the power roller 4 and the input disc 2, that is, a direction against the rotation direction of the input discs 2 (a direction along a rotation direction of the output disc 3)). At the contact point of the power roller 4 and the input disc 2, a force in a circumferential direction of the input disc 2 acts on the power roller 4, and thus a tiltable rotation force acts on the power roller 4 in a direction where the power roller 4 is moved to a peripheral side of the input disc 2 (in a direction where the power roller 4 is separated from the rotation axis X1 of the input discs 2). As a result, since the power roller 4 tiltably rotates so that the contact point thereof with the input disc 2 moves to an outside of the input disc 2 in the radial direction as well as the contact point thereof with the output disc 3 moves to an inside of the output discs 3 in the radial direction, the transmission ratio is changed to a speed reducing side and a transmission is shifted up. When the power roller 4 returns to the neutral position again, the changed transmission ratio is fixed.

On the contrary, when a transmission is shifted down, the power roller 4 is offset in the first direction A1 along the rotation axis X3 (a moving direction of the input disc 2 at the contact point of the power roller 4 and the input disc 2, that is, a direction along the rotation direction of the input disc 2 (a direction against the rotation direction of the output disc 3)). At the contact point of the power roller 4 and the input disc 2, a force in the circumferential direction of the input disc 2 acts on the power roller 4, and thus a tiltable rotation force acts on the power roller 4 in a direction where the power roller 4 is moved to a center side of the input disc 2 (in a direction where the power roller 4 is approached to the rotation axis X1 of the input disc 2). As a result, since the power roller 4 tiltably rotates so that the contact point thereof with the input disc 2 moves to an inside of the input disc 2 in the radial direction as well as the contact point thereof with the output disc 3 moves to an outside of the output disc 3 in the radial direction, the transmission ratio is changed to a speed increasing side and a transmission is shifted down. When the power roller 4 returns to the neutral position again, the changed transmission ratio is fixed.

A position of the power roller 4 is determined by a stroke amount and a tiltable rotation angle to the input disc 2 and the output disc 3. When the neutral position, at which the rotation axis X2 of the power roller 4 passes through the rotation axis X1 of the input disc 2 and the output disc 3 is used as a reference position, the stroke amount of the power roller 4 is an amount in response to a stroke amount as a moving amount from the neutral position in the first direction A1 or the second direction A2, more specifically, an amount in response to a stroke amount (offset amount) from the neutral position. When a position, where the rotation axis X2 which is a center of rotation of the power roller 4 is orthogonal to the rotation axis X1 which is a center of rotation of the input disc 2 and the output disc 3, is used as a reference position, a tiltable rotation angle of the power roller 4 is a tilt angle (a tilt angle on an acute angle side) to the input disc 2 and the output disc 3 from the reference position and is, in other words, a rotation angle about the rotation axis X3.

The transmission ratio of the toroidal type continuously variable transmission 1 is determined by a tiltable rotation angle of the power roller 4 to the input disc 2 and the output disc 3, and the tiltable rotation angle is determined by an integration value of a stroke amount (offset amount) from the neutral position of the power roller 4.

The toroidal type continuously variable transmission 1 is provided with a lower link mechanism 16 and an upper link mechanism 17 as mechanisms which synchronize movements of the pair of the power rollers 4 and the pair of trunnions 6 disposed to each pair of input discs 2 and output disc 3 in a reverse direction along the rotation axis X3.

The lower link mechanism 16 includes the lower link 16a as a link member, whereas the upper link mechanism 17 includes the upper link 17a as a link member. The lower link 16a couples a pair of trunnions 6 via a bearing unit (radial bearing) 6f which is a spherical bearing on one end side to which the transmission shift control piston 81 is disposed in the rotating shafts 6b of the trunnions 6 (between the cylinder body 86 and one shoulder portion 6e of the roller support portion 6a). The upper link 17a couples a pair of trunnions 6 via a bearing unit (radial bearing) 6f which is a spherical bearing on the other end side in the rotating shafts 6b of the trunnions (the other shoulder portion 6e side of the roller support portion 6a).

The lower link 16a and the upper link 17a are supported by a lower support shaft 16c of a lower post 16b fixed to the casing 1a via the cylinder body 86 and by an upper support shaft 17c of an upper post 17b fixed to the casing 1a, respectively. The lower support shaft 16c and the upper support shaft 17c are formed in a columnar shape together and fixedly disposed so as not to relatively move to the casing 1a so that a center axis of the lower support shaft 16c and the upper support shaft 17c are in a direction parallel with the rotation axis X1. Since the lower link 16a and the upper link 17a are supported by the lower support shaft 16c and the upper support shaft 17c, respectively, the lower link 16a and the upper link 17a are configured to able to swing with a seesaw motion using the lower support shaft 16c and the upper support shaft 17c as fulcrums, that is, using the center axis of the lower support shaft 16c and the upper support shaft 17c as a swing axis X4.

Accordingly, the lower link mechanism 16 and the upper link mechanism 17 can synchronize the movements of the pair of the trunnions 6 in the reverse direction along the rotation axis X3 by that the lower link 16a and the upper link 17a swing about the swing axis X4 which is the center axis of the lower support shaft 16c and the upper support shaft 17c. Note that the upper post 17b is attached with a nozzle 17d which is disposed with an injection hole 17e, and the traction oil described above is injected from the injection hole 17e.

Further, the toroidal type continuously variable transmission 1 is provided with a synchronous mechanism 18 as a mechanism which promotes a synchronization of rotations of the trunnions 6 about the rotation axes X3. The synchronous mechanism 18 includes a synchronous wire 19 and a plurality of fixed pulleys 20. The synchronous mechanism 18 can promote the synchronization of rotations of the trunnions 6 about the rotation axes X3 by transmitting rotation torque of the trunnions 6 on one hand to the trunnions 6 on the other hand by a friction force between the fixed pulleys 20 fixedly disposed to the rotating shafts 6b of the trunnions 6 and the synchronous wire 19 which is stretched by being reversed so as to intersect once between fixed pulleys 20 which are adjacent in the rotation axis X1 direction or in the rotation axis X2 direction.

As a result, in the tiltable rotation operations (transmission shift operations) of the power rollers 4 and the trunnions 6, even when a nip-pressure of the hydraulic press mechanism 15 does not uniformly act on the plurality of power rollers 4 due to a dispersion and the like of parts accuracy and assembly accuracy of the trunnions 6 as support structures of the power rollers 4 and even when a transmission shift responsiveness is minutely offset by a difference and the like of an oil passage resistance of the hydraulic pressure controlling device 9, since the synchronous mechanism 18 can mutually synchronize the tiltable rotation operations of the power roller 4 by mutually associating and synchronizing the rotations of the trunnions 6, a transmission shift control accuracy of the toroidal type continuously variable transmission 1 can be improved.

The ECU 60 controls a drive of the toroidal type continuously variable transmission 1, in particular, controls the transmission ratio γ, and here the ECU 60 performs an operation control of the engine 21 based on various input signals and various maps that are input from the sensors attached to the respective sections of the vehicle on which the engine 21 is mounted, for example, an injection control of a not shown fuel injection valve, a degree of opening of throttle control of a not shown throttle valve which controls an intake air amount of the engine 21, an ignition control of an ignition plug, and the like. Then, the ECU 60 controls drives of respective sections of the toroidal type continuously variable transmission 1 in response to an operation state of the toroidal type continuously variable transmission 1 to thereby control an actual transmission ratio which is an actual transmission ratio of the toroidal type continuously variable transmission 1. More specifically, the ECU 60 determines a target transmission ratio as an intended transmission ratio based on, for example, operation states such as an engine number of revolution, a throttle degree of opening, an accelerator degree of opening, an engine number of revolution, an input number of revolution, an output number of revolution, a shift position, and the like and a tiltable rotation angle, a stroke amount, and the like which are detected by the various sensors as well as changes the transmission ratio by moving the power roller 4 from the neutral position to the transmission shift position side in a predetermined stroke amount by driving the transmission ratio changing unit 5 and tiltably rotating the power roller 4 up to a predetermined tiltable rotation angle. More specifically, the ECU 60 controls hydraulic pressures of the first hydraulic pressure chamber OP1 and the second hydraulic pressure chamber OP2 of the hydraulic piston unit 8 by duty controlling a drive current supplied to the flow rate control valve of the hydraulic pressure controlling device 9 based on a control command value and moves the power roller 4 together with the trunnion 6 from the neutral position to the transmission shift position side up to a predetermined stroke amount and tiltably rotates the power roller 4 up to the predetermined tiltable rotation angle so that the actual transmission ratio becomes the target transmission ratio.

In the toroidal type continuously variable transmission 1, when the driving force (torque) is input to the input disc 2, the driving force is transmitted to the power roller 4, which is in contact with the input disc 2 via the traction oil and further the driving force is transmitted from the power roller 4 to the output disc 3 via the traction oil. During the period, since a glass transition occurs in the traction oil because the traction oil is pressurized, the driving force is transmitted by a large shear force resulting from the glass transition. As a result, the input discs 2 and the output discs 3 are pressed by the hydraulic press mechanism 15 so that a nip-pressure corresponding to the input torque is generated between the input discs 2 and output discs 3 and the power roller 4. Further, since a peripheral speed of the power roller 4 is substantially the same as peripheral speeds of the input discs 2 and the output discs 3 at torque transmission points (contact points where the power roller 4 is in contact with the input discs 2 and output discs 3 via the traction oil), numbers of revolution (rotation speeds) of the input discs 2 and the output discs 3 are different in response to a radius of the contact points of the input discs 2 and the power roller 4 from the rotation axis X1 and a radius of the contact points of the power roller 4 and the output discs 3 from the rotation axis X1, and thus a ratio of the numbers of revolution (rotation speeds) becomes the transmission ratio.

When the ECU 60 changes the transmission ratio the set target transmission ratio, that is, when the ECU 60 changes the transmission ratio, the ECU 60 supplies the drive current to the flow rate control valve of the hydraulic pressure controlling device 9 based on a rotation direction of the input disc 2 (or the output disc 3) and controls the hydraulic pressures of the first hydraulic pressure chamber OP1 and the second hydraulic pressure chamber OP2, thereby moving the trunnion 6 from the neutral position in the first direction A1 or in the second direction A2 until the power roller 4 become a tiltable rotation angle in response to the target transmission ratio. For example, in a state that the input disc 2 is rotated in an arrow B direction (counterclockwise) in FIG. 2, when the power roller 4 is moved from the neutral position in the first direction A1 along the rotation axis X3 by the hydraulic pressure of the first hydraulic pressure chamber OP1, the transmission ratio increases as described above and a shift down is performed. In contrast, in a state that the input disc 2 is rotated in the arrow B direction (counterclockwise) in FIG. 2, when the power roller 4 is moved from the neutral position in the second direction A2 along the rotation axis X3 by the hydraulic pressure of the second hydraulic pressure chamber OP2, the transmission ratio decreases as described above and a shift up is performed. Further, when the set transmission ratio is fixed, the trunnion 6 is moved in the first direction A1 or in the second direction A2 until the power roller 4 returns to the neutral position again.

Note that the ECU 60 performs a cascade type feed back control based on, for example, a tiltable rotation angle of the power roller 4 detected by a tiltable rotation angle sensor (not shown) and the stroke amount detected by a stroke sensor (not shown) so that the actual transmission ratio (actually employed transmission ratio) becomes the target transmission ratio (the target transmission ratio after transmission shifted). That is, the ECU 60 determines a target tiltable rotation angle as a target tiltable rotation angle corresponding to the target transmission ratio based on the accelerator degree of opening and the vehicle speed, determines the target transmission ratio and a target stroke amount which is a target stroke amount corresponding to the target tiltable rotation angle based on a difference between the target tiltable rotation angle and the actual tiltable rotation angle which is an actually employed tiltable rotation angle detected by the tiltable rotation angle sensor, and controls the hydraulic pressure controlling device 9 of the moving unit 7 so that the stroke amount detected by the stroke sensor becomes the target stroke amount.

That is, the ECU 60 determines the target transmission ratio as the intended transmission ratio from the accelerator degree of opening, the vehicle speed, and the like. For example, a requested driving force is calculated based on a requested drive amount shown by the accelerator degree of opening and the like and the vehicle speed, a target output is determined from the requested driving force and the vehicle speed, a number of revolution of engine which achieves the target output by a minimum fuel consumption is determined, and the target transmission ratio is determined so that a number of revolution of input to the toroidal type continuously variable transmission 1 becomes a target number of revolution corresponding to the number of revolution of engine, that is, becomes a target input number of revolution. When the contact points of the power roller 4 and the input disc 2 and the output disc 3 are found, since the relation between the transmission ratio and the tiltable rotation angle is determined only by a geometrical shape, the target tiltable rotation angle can be determined from the target transmission ratio.

Note that in the transmission shift control of the toroidal type continuously variable transmission 1, it is basically sufficient to feedback control only the tiltable rotation angle (in other words, the transmission ratio) detected by the tiltable rotation angle sensor. However, since the stroke amount corresponds to a differential of the tiltable rotation angle, a damping effect which suppresses vibration in a tiltable rotation control can be obtained by also performing a feedback control of the stroke amount detected by the stroke sensor. Further, the ECU 60 may perform a feedforward control together with the feedback control to improve a responsiveness of the transmission ratio.

Incidentally, in the toroidal type continuously variable transmission 1, when, the vehicle on which the toroidal type continuously variable transmission 1 is mounted is operated in, for example, a state that the hydraulic pressure of the working oil supplied to the transmission shift control hydraulic pressure chamber 82 to act the transmission shift control press force on the trunnions 6 drops and the transmission shift control press force does not act on the trunnions 6, there is a possibility that the transmission ratio is changed to the speed reducing side (speed increasing side) a transmission is shifted up. That is, in, for example, a case in which the oil pump 9a, which pressurizes the working oil supplied to the transmission shift control hydraulic pressure chamber 82, is driven in association with the rotation of the crank shaft 21a of the drive source such as the engine 21 as described above, when the drive wheels 27 are rotated by that the vehicle on which the toroidal type continuously variable transmission 1 is mounted is pulled or idly travels in, for example, an operation state that a drive of the oil pump 9a is stopped together with the engine 21 and an appropriate transmission shift control press force cannot act on the flange portion 84 disposed to the trunnion 6, a rotation force is inversely input to the output disc 3 via a propeller shaft and the like and the output disc 3 is also rotated. As a result, a tangential force acts on the power roller 4 from the output disc 3 using a friction on input disc 2 side as a reaction force receiver. Then, when the tangential force act on the power roller 4, since the transmission shift control press force does not act on the trunnion 6, the power roller 4 cannot resist the tangential force. As a result, in any case in which the output disc 3 rotates forward or backward, there is a possibility that the power roller 4 is offset in a direction along the rotation direction of the output disc 3. Then, there is a possibility that the tangential force acts between the power roller 4 and the output disc 3 and the side slip is generated, and the power roller 4 tiltably rotates and the transmission ratio is changed to the speed reducing side and shifted up to a high speed side transmission ratio. Therefore, when the vehicle starts and departs next, there is a possibility that the vehicle must depart in a state that the transmission ratio is relatively small. As a result, there is a possibility that startability is deteriorated by an insufficient amount of torque and the like. Accordingly, in the toroidal type continuously variable transmission 1, it is desired to prevent an unintentional transmission shift as described above in, for example, an operation state that the transmission shift control press force cannot act on the trunnion 6.

Thus, in the toroidal type continuously variable transmission 1 of the embodiment, as shown in FIG. 5, the unintentional transmission shift is prevented by providing a coupling oil passage 101, which couples the hydraulic pressure controlling device 9 with the nip-pressure generation hydraulic chamber 15a as a hydraulic pressure controlling means, with a pressure release mechanism 100 as a pressure release means which can release the hydraulic pressure (pressure) of the working oil (working fluid) of the nip-pressure generation hydraulic chamber 15a via a release unit 102 in response to an operation state. Further, in the toroidal type continuously variable transmission 1 of the embodiment, the pressure release mechanism 100 improves a responsiveness of reduction of the hydraulic pressure of the nip-pressure generation hydraulic chamber 15a and a responsiveness of return of the hydraulic pressure of the nip-pressure generation hydraulic chamber 15a by positioning the release unit 102 upward of the nip-pressure generation hydraulic chamber 15a in the vertical direction in a state that the pressure release mechanism 100 is mounted on the vehicle, thereby appropriately preventing the unintentional transmission shift.

As described above, the nip-pressure generation hydraulic chamber 15a of the hydraulic press mechanism 15 is partitioned by the front side input disc nip-pressure press force application surface 28 and the rear side input disc nip-pressure press force application surface 29 between the nip-pressure press force piston 15b and the front side input disc 2_{F} to the direction along the rotation axis X1. More specifically, the hydraulic press mechanism 15 is provided with an annular seal member S5 between an inner peripheral surface of a cylindrical portion of the nip-pressure press force piston 15b and an outer peripheral surface of a cylindrical portion of the front side input disc 2_{F}. Accordingly, the working oil supplied into the nip-pressure generation hydraulic chamber 15a is sealed by the seal member S5 between the nip-pressure press force piston 15b and the front side input disc 2_{F} so that the working oil does not leak to the outside.

In the nip-pressure generation hydraulic chamber 15a, an introduction/discharge port 15c, which supplies the working oil to the nip-pressure generation hydraulic chamber 15a or discharges the working oil from the nip-pressure generation hydraulic chamber 15a, is connected with the coupling oil passage 101. The working oil can flow in the coupling oil passage 101 and connects the nip-pressure generation hydraulic chamber 15a to the hydraulic pressure controlling device 9. That is, the nip-pressure generation hydraulic chamber 15a is coupled with the hydraulic pressure controlling device 9 via the coupling oil passage 101. Accordingly, the hydraulic press mechanism 15 can apply a nip-pressure which causes the input disc 2 and the output disc 3 (refer to FIG. 1) to come into contact with the power roller 4 (refer to FIG. 1) by the hydraulic pressure of the working oil, which is supplied from the hydraulic pressure controlling device 9 that controls the hydraulic pressure of the working oil to the nip-pressure generation hydraulic chamber 15a via the coupling oil passage 101, and nips the power roller 4 between the input disc 2 and the output disc 3.

The pressure release mechanism 100 is disposed to the coupling oil passage 101 and can release the hydraulic pressure of the working oil of the nip-pressure generation hydraulic chamber 15a via the release unit 102 in response to an operation state. The release unit 102 releases the hydraulic pressure of the working oil of the nip-pressure generation hydraulic chamber 15a via a part of the coupling oil passage 101. The release unit 102 is a portion where an inside space portion of the coupling oil passage 101 communicates with an outside space portion of the coupling oil passage 101, releases the hydraulic pressure of the working oil of the nip-pressure generation hydraulic chamber 15a to the atmosphere of, for example, the outside space portion of the coupling oil passage 101 in response to an operation state, and reduces the hydraulic pressure to a predetermined release pressure (for example, a pressure corresponding to the atmospheric pressure). Further, the pressure release mechanism 100 includes a branch release oil passage 103 and a switch valve 104 as a switch means.

The branch release oil passage 103 is an oil passage branched from the coupling oil passage 101 and the working oil can flow therein. An end side of the branch release oil passage 103 is connected to the switch valve 104, and the branch release oil passage 103 can communicate with the coupling oil passage 101 via the switch valve 104. Further, a release opening 103a as an opening on the other end side of the branch release oil passage 103 acts as the release unit 102. That is, the branch release oil passage 103 is disposed with the switch valve 104 on the one end side, whereas the branch release oil passage 103 is disposed with the release opening 103a acting as the release unit 102 on the other end side.

A position of the release opening 103a, which acts as the release unit 102 of the embodiment, is set upward in the vertical direction of the nip-pressure generation hydraulic chamber 15a in a state that the toroidal type continuously variable transmission 1 is mounted on the vehicle. More Specifically, the release opening 103a is disposed at a vertical direction position H2 upward in the vertical direction of a vertical direction position H1 of an upper side end of the nip-pressure generation hydraulic chamber 15a in the vertical direction. The release opening 103a acting as the release unit 102 is disposed so as to face downward in the vertical direction at the vertical direction position H2 upward of the vertical direction position H1 in the vertical direction.

Note that the pressure release mechanism 100 is provided with a reservoir 105 which is disposed downward in the vertical direction of the release opening 103a acting as the release unit 102 and can store the working oil discharged from the release opening 103a. The reservoir 105 is disposed at a position which confronts the release opening 103a acting as the release unit 102 to the vertical direction.

The switch valve 104 is disposed on the coupling oil passage 101 and switches a connection state of the coupling oil passage 101 and the branch release oil passage 103 in response to an operation state. The branch release oil passage 103 is configured so as to be branched from the coupling oil passage 101 by the switch valve 104.

The coupling oil passage 101 is configured including a hydraulic chamber side oil passage 101a positioned on the nip-pressure generation hydraulic chamber 15a side and a control unit side oil passage 101b positioned on the hydraulic pressure controlling device 9 side across the switch valve 104. The hydraulic chamber side oil passage 101a is an oil passage positioned between the switch valve 104 and the nip-pressure generation hydraulic chamber 15a in the coupling oil passage 101. An end side of the hydraulic chamber side oil passage 101a is connected to the introduction/discharge port 15c of the nip-pressure generation hydraulic chamber 15a, whereas the other end side thereof is connected to the switch valve 104. In the coupling oil passage 101, the control unit side oil passage 101b is an oil passage of a portion positioned between the switch valve 104 and the hydraulic pressure controlling device 9. An end side of the control unit side oil passage 101b is connected to the hydraulic pressure controlling device 9, whereas the other end side of the control unit side oil passage 101b is connected to the switch valve 104.

An electromagnetic valve is applied as the switch valve 104, the electromagnetic valve being driven by supplying a predetermined current to a solenoid 104a, and the electromagnetic valve can switch the nip-pressure generation hydraulic chamber 15a to a close state that the nip-pressure generation hydraulic chamber 15a is connected to the hydraulic pressure controlling device 9 and to a release state that the nip-pressure generation hydraulic chamber 15a is connected to the release unit 102. In the close state, the switch valve 104 causes the nip-pressure generation hydraulic chamber 15a to communicate with the hydraulic pressure controlling device 9 as well as shuts off a communication of the nip-pressure generation hydraulic chamber 15a with the release unit 102.

In the close state, the switch valve 104 connects the hydraulic chamber side oil passage 101a to the control unit side oil passage 101b to thereby permit a flow of the working oil between the hydraulic chamber side oil passage 101a and the control unit side oil passage 101b. That is, in the close state, the switch valve 104 connects the hydraulic chamber side oil passage 101a to the control unit side oil passage 101b to thereby connect the nip-pressure generation hydraulic chamber 15a to the hydraulic pressure controlling device 9 via the hydraulic chamber side oil passage 101a and the control unit side oil passage 101b. With the operation, the pressure release mechanism 100 can achieve a shut-off state that a release of the hydraulic pressure of the working oil of the nip-pressure generation hydraulic chamber 15a via the release opening 103a acting as the release unit 102 is shut off, and the hydraulic pressure controlling device 9 can control the nip-pressure press force generated by the hydraulic press mechanism 15 to a predetermined magnitude based on the input torque to the toroidal type continuously variable transmission 1 by controlling an amount or a hydraulic pressure of the working oil supplied to the nip-pressure generation hydraulic chamber 15a.

In the release state, the switch valve 104 connects the hydraulic chamber side oil passage 101a to the branch release oil passage 103 to thereby permit the flow of the working oil to between the hydraulic chamber side oil passage 101a and the branch release oil passage 103. That is, in the release state, the switch valve 104 connects the hydraulic chamber side oil passage 101a to the branch release oil passage 103 to thereby connect the nip-pressure generation hydraulic chamber 15a and the release opening 103a acting as the release unit 102 via the hydraulic chamber side oil passage 101a and the branch release oil passage 103. With the operation, the pressure release mechanism 100 can achieve a release state that the hydraulic pressure of the working oil of the nip-pressure generation hydraulic chamber 15a is released via the release opening 103a acting as the release unit 102.

The switch valve 104 of the embodiment is connected to the ECU 60 by which a drive of switch valve 104 is controlled. The switch valve 104 is configured of an electromagnetic valve which is placed in a close state when the solenoid 104a is energized (in an ON control state), whereas the electromagnetic valve is placed in a release state when the solenoid 104a is disenergized (in an OFF control state). The switch valve 104 is configured including an elastic member 104b together with, for example, the solenoid 104a. When a drive current supplied to the solenoid 104a is set to a predetermined magnitude, since a press force, which is generated by the solenoid 104a and acts on a not shown spool valve element, becomes larger than an urging force generated by the elastic member 104b and the spool valve element moves to an ON position, the switch valve 104 is placed in an ON state (a state of an ON portion shown in FIG. 5), that is, placed in a close state that the nip-pressure generation hydraulic chamber 15a is connected to the hydraulic pressure controlling device 9. When the drive current supplied to the solenoid 104a is set to 0 A, since the press force, which is generated by the solenoid 104a and acts on the not shown spool valve element, becomes smaller than the urging force generated by the elastic member 104b and acts on the spool valve element and the spool valve element moves to an OFF position, the switch valve 104 is placed in an OFF state (state of an OFF portion shown in FIG. 5), that is, placed in a release state that the nip-pressure generation hydraulic chamber 15a is connected to the release opening 103a acting as the release unit 102.

Further, in the state that the toroidal type continuously variable transmission 1 is mounted on the vehicle, a position of the switch valve 104 of the embodiment in the vertical direction is set upward in the vertical direction of the nip-pressure generation hydraulic chamber 15a. More specifically, the switch valve 104 is disposed upward in the vertical direction of the vertical direction position H1 of an upper side end portion of the nip-pressure generation hydraulic chamber 15a in the vertical direction. The switch valve 104 is disposed at an uppermost side position in the vertical direction on the coupling oil passage 101.

The ECU 60 controls the drive current, which is supplied to the solenoid 104a in response to an operation state of the vehicle on which the toroidal type continuously variable transmission 1, the engine 21, and the like, thereby controlling a working state of the pressure release mechanism 100. In the operation state that the transmission shift control press force cannot act on the trunnion 6, when, for example, the engine 21 is placed in an ordinary stop state and the drive of the oil pump 9a, which can pressurize the working oil by being driven in association with a rotation of the crank shaft 21a, is in a stop state, the pressure release mechanism 100 is basically controlled by the ECU 60 and releases the hydraulic pressure of the working oil of the nip-pressure generation hydraulic chamber 15a.

When the engine 21 is in the stop state, the pressure release mechanism 100 of the embodiment is placed in a release state that the hydraulic pressure of the working oil of the nip-pressure generation hydraulic chamber 15a is released via the release opening 103a acting as the release unit 102 by that the switch valve 104 is controlled by the ECU 60 so as to be placed in a release state that the nip-pressure generation hydraulic chamber 15a is connected to the release unit 102.

In contrast, when the engine 21 is placed in a working state, the pressure release mechanism 100 is placed in a shut-off state that the release of the hydraulic pressure of the working oil of the nip-pressure generation hydraulic chamber 15a via the release opening 103a acting as the release unit 102 is shut off by that the switch valve 104 is controlled by the ECU 60 so as to be placed in a close state that the nip-pressure generation hydraulic chamber 15a is connected to the hydraulic pressure controlling device 9. The ECU 60 can determine the stop state and the working state of the engine 21 based on the various input signals input from the sensors attached to the respective sections of the vehicle on which the toroidal type continuously variable transmission 1 and the engine 21 are mounted.

Further, when the engine 21 is in a temporary stop state in a so-called idling stop control, the pressure release mechanism 100 of the embodiment is placed in the shut-off state that the release of the hydraulic pressure of the working oil of the nip-pressure generation hydraulic chamber 15a via the release opening 103a acting as the release unit 102 is shut off by that the switch valve 104 is controlled by the ECU 60 so as to be placed in the close state that the nip-pressure generation hydraulic chamber 15a is connected to the hydraulic pressure controlling device 9. The idling stop control of the engine 21 is a control which automatically stops an idling operation. In the idling stop control, the ECU 60 temporarily stops the engine 21 by detecting, for example, a stop of the vehicle and restarts the engine 21 by detecting a departure operation of the vehicle. When the ECU 60 determines, for example, that the vehicle is placed in a state that it is apparent that the vehicle stops as well as does not travel for a predetermined period, the ECU 60 performs the idling stop control. That is, when a driver operates a brake pedal of the vehicle and temporarily stops due to a stop at a red light and the like at an intersection point, the ECU 60 automatically stops the engine 21 (idling stop). At the time, the pressure release mechanism 100 is placed in the shut-off state that the release of the hydraulic pressure of the working oil of the nip-pressure generation hydraulic chamber 15a via the release opening 103a acting as the release unit 102 is shut off in the control of the ECU 60. Thereafter, when the operation of the brake pedal is released and an accelerator pedal is depressed, the ECU 60 restarts the engine 21. The ECU 60 can determine the temporary stop state in the idling stop control of the engine 21 based on the various input signals input from the sensors attached to the respective sections of the vehicle on which the toroidal type continuously variable transmission 1 and the engine 21 are mounted.

When an ignition key is turned on and the engine 21 starts and is placed in the working state, the toroidal type continuously variable transmission 1 configured as described is placed in the operation state that the oil pump 9a is driven and the transmission shift control press force can act on the flange portion 84 of the transmission shift control piston 81. In the operation state that the engine 21 is placed in the working state and the transmission shift control press force can act on the flange portion 84 of the transmission shift control piston 81, the toroidal type continuously variable transmission 1 is placed in the shut-off state that the switch valve 104 of the pressure release mechanism 100 is controlled to the close state by the ECU 60 and the release of the hydraulic pressure of the working oil of the nip-pressure generation hydraulic chamber 15a via the release opening 103a acting as the release unit 102 is shut off. The toroidal type continuously variable transmission 1 causes the input discs 2 to approach the output disc 3 by the nip-pressure press force of the working oil of the hydraulic press mechanism 15 by that the amount or the hydraulic pressure of the working oil supplied into the nip-pressure generation hydraulic chamber 15a of the hydraulic press mechanism 15 is controlled by the hydraulic pressure controlling device 9 and applies the nip-pressure which nips the power roller 4 between the input disc 2 and the output disc 3 in a predetermined magnitude based on the input torque. As a result, the toroidal type continuously variable transmission 1 can prevent a slip between the input disc 2, the output disc 3 and the power roller 4, keep an appropriate traction state, and appropriately transmit a power between the input disc 2, the output disc 3 and the power roller 4.

When the transmission ratio is changed (when a transmission shift is performed), the toroidal type continuously variable transmission 1 can change the transmission ratio by tiltably rotating the power roller 4 together with the trunnion 6 to the input disc 2 and the output disc 3 by that a predetermined transmission shift control press force is applied to the flange portion 84 of the transmission shift control piston 81 by the hydraulic pressure controlling device 9. Further, when the transmission ratio is fixed (in a fixed transmission ratio), the toroidal type continuously variable transmission 1 can fix the transmission ratio by fixing positions of the power roller 4 and the trunnion 6 which supports the power roller 4 at the neutral position by that the transmission shift control press force, which has a magnitude that resists the tangential force acting on the contact points of the input disc 2, the output disc 3 and the power roller 4, is applied to the flange portion 84 of the transmission shift control piston 81 by the hydraulic pressure controlling device 9 in response to the input torque.

In contrast, when the engine 21 is placed in an operation stop state by, for example, turning OFF the ignition key, the toroidal type continuously variable transmission 1 is placed in a state that the drive of the oil pump 9a is stopped and the transmission shift control press force cannot act on the flange portion 84 of the transmission shift control piston 81. The oil pump 9a is driven in association with the rotation of the crank shaft 21a of the engine 21 which generates the driving force, thereby pressurizing the working oil which operates the hydraulic piston unit 8 of the transmission ratio changing unit 5, and the working oil which operates the hydraulic press mechanism 15. More specifically, the working oil, which operates the hydraulic piston unit 8 of the transmission ratio changing unit 5 and the working oil, which operates the nip-pressure press force piston 15b of the hydraulic press mechanism 15 are pressurized by the common oil pump 9a to the line pressure, and an original pressure of the working oil, which operates the hydraulic piston unit 8 of the transmission ratio changing unit 5, and an original pressure of the working oil, which operates the nip-pressure press force piston 15b of the hydraulic press mechanism 15 are made to a common original pressure. Accordingly, in the toroidal type continuously variable transmission 1, when the state, in which the transmission shift control press force cannot act on the flange portion 84 of the transmission shift control piston 81, occurs, the nip-pressure press force cannot act also on the nip-pressure press force piston 15b of the hydraulic press mechanism 15.

In the operation state, in which the engine 21 is placed in the stop state and the transmission shift control press force cannot act on the flange portion 84 of the transmission shift control piston 81, the toroidal type continuously variable transmission 1 is placed in the release state that the switch valve 104 of the pressure release mechanism 100 is controlled to the release state by the ECU 60 and the hydraulic pressure of the working oil of the nip-pressure generation hydraulic chamber 15a is released via the release opening 103a acting as the release unit 102. The toroidal type continuously variable transmission 1 can promptly reduce the hydraulic pressure of the working oil of the nip-pressure generation hydraulic chamber 15a to a predetermined release pressure (for example, the pressure corresponding to the atmospheric pressure) by that the switch valve 104 is controlled to the release state and the hydraulic pressure of the working oil of the nip-pressure generation hydraulic chamber 15a is placed in the release state via the release opening 103a acting as the release unit 102. As a result, when the engine 21 stops, since the hydraulic pressure of the working oil of the nip-pressure generation hydraulic chamber 15a is promptly reduced to the predetermined release pressure by that the switch valve 104 is switched to the release state, the toroidal type continuously variable transmission 1 can promptly reduce the nip-pressure press force of the working oil of the hydraulic press mechanism 15 and thus can shut off a transmission of power between the input disc 2, the output disc 3 and the power roller 4 with a good responsiveness when the engine 21 stops.

In a state that the hydraulic pressure of the working oil supplied to the transmission shift control hydraulic pressure chamber 82 drops and the transmission shift control press force does not act on the trunnion 6, that is, when the engine 21 is placed in the stop state here, even if the transmission of power between the input disc 2, the output disc 3 and the power roller 4 is shut off and the drive wheels 27 are rotated and thus the output disc 3 is also rotated by that the vehicle on which the toroidal type continuously variable transmission 1 is mounted is pulled, idly travels, and the like, the toroidal type continuously variable transmission 1 can prevent that the tangential force acts on the power roller 4 from output disc 3. As a result, since the toroidal type continuously variable transmission 1 can prevent that the tangential force acts on the power roller 4 from output disc 3, the toroidal type continuously variable transmission 1 prevents that the power roller 4 tiltably rotates and thus can prevent the unintentional transmission shift, that is, the toroidal type continuously variable transmission 1 can prevent that the transmission ratio is changed to the speed reducing side and is shifted up to the high speed side transmission ratio. With the operation, the toroidal type continuously variable transmission 1 can prevent that startability is deteriorated by the insufficient amount of torque and the like. Further, since it is not necessary to separately provide an output rotation drive pump, which is not particularly used in an ordinary travel, to cause a press force, which resists the tangential force that acts on the power roller 4 from output disc 3 when, for example, the drive wheels 27 are rotated, on the trunnion 6, an increase of size, cost, and the like of the device can be prevented. Further, when output rotation drive pump is separately provided as described above, although a predetermined transmission shift control must be continuously performed, for example, while the vehicle is pulled, since the transmission of power is shut off between the input disc 2, the output disc 3 and the power roller 4 in the toroidal type continuously variable transmission 1 of the embodiment, it is not necessary to perform the transmission shift control while the vehicle is pulled so that a useless electricity consumption can be suppressed.

As described above, in the toroidal type continuously variable transmission 1, when the engine 21 stops, since the switch valve 104 is switched to the release state and the hydraulic pressure of the working oil of the nip-pressure generation hydraulic chamber 15a is promptly reduced to the predetermined release pressure when the engine 21 stops, the transmission of power between the input disc 2, the output disc 3 and the power roller 4 can be shut off with a good responsiveness. As a result, since it can be prevented that the power is transmitted between the input disc 2, the output disc 3 and the power roller 4 due to a remaining pressure of the working oil of the nip-pressure generation hydraulic chamber 15a, the unintentional transmission shift can be appropriately prevented.

In the toroidal type continuously variable transmission 1, when the hydraulic pressure of the working oil of the nip-pressure generation hydraulic chamber 15a is placed in the release state via the release opening 103a acting as the release unit 102, the working oil is discharged from the release opening 103a acting as the release unit 102 to the reservoir 105 as the hydraulic pressure is released (that is, as the hydraulic pressure is reduced). In the toroidal type continuously variable transmission 1 of the embodiment, since the release opening 103a acting as the release unit 102 is positioned upward in the vertical direction of the nip-pressure generation hydraulic chamber 15a, the working oil remains in portions downward in the vertical direction of the vertical direction position H2 of the release opening 103a in the nip-pressure generation hydraulic chamber 15a, the coupling oil passage 101, and the hydraulic pressure controlling device 9. That is, the working oil, which remains in the portions downward in the vertical direction of the vertical direction position H2 of the release opening 103a, remains in the nip-pressure generation hydraulic chamber 15a, the coupling oil passage 101, and the hydraulic pressure controlling device 9 in a filled state as it is.

Further, in the toroidal type continuously variable transmission 1 of the embodiment, the switch valve 104 is positioned upward in the vertical direction of the nip-pressure generation hydraulic chamber 15a. Accordingly, even if the working oil leaks from portions where the switch valve 104 is connected to the hydraulic chamber side oil passage 101a, the control unit side oil passage 101b, and the branch release oil passage 103, and the like, due to, for example, a dispersion and the like resulting from a deformation of the switch valve 104 and parts accuracy, the working oil can be securely remained in portions downward in the vertical direction of the vertical direction position of at least the portion from which the working oil leaks in the nip-pressure generation hydraulic chamber 15a, the coupling oil passage 101, and the hydraulic pressure controlling device 9.

When the engine 21 is restarted by turning ON the ignition key and placed in the working state and the toroidal type continuously variable transmission 1 is placed in the operation state that the oil pump 9a is driven and the transmission shift control press force can act on the flange portion 84 of the transmission shift control piston 81, the switch valve 104 of the pressure release mechanism 100 is controlled to the close state by the ECU 60 and the hydraulic pressure of the working oil of the nip-pressure generation hydraulic chamber 15a is placed in the shut-off state that the release of the hydraulic pressure via the release opening 103a acting as the release unit 102 is shut off. At the time, the working oil, which remains in the portions downward in the vertical direction of the vertical direction position H2 of the release opening 103a, remains in the nip-pressure generation hydraulic chamber 15a, the coupling oil passage 101, and the hydraulic pressure controlling device 9 as it is in the filled state. Accordingly, the hydraulic pressure of the working oil of the nip-pressure generation hydraulic chamber 15a can be promptly increased from the hydraulic pressure controlling device 9 via the coupling oil passage 101 by an action of the working oil which remains in the nip-pressure generation hydraulic chamber 15a, the coupling oil passage 101, and the hydraulic pressure controlling device 9 in the filled state. As a result, in the toroidal type continuously variable transmission 1, since the hydraulic pressure of the working oil of the nip-pressure generation hydraulic chamber 15a is promptly increased, the nip-pressure press force of the working oil of the hydraulic press mechanism 15 can be promptly increased and thus the nip-pressure, which nips the power roller 4 between the input disc 2 and the output disc 3 can be applied with a good responsiveness when the engine 21 starts. With the operation, the toroidal type continuously variable transmission 1 can shift to the transmission shift control performed by the transmission ratio changing unit 5 with a good responsiveness when the engine 21 starts. That is, occurrence of a delay of restart and departure of the vehicle on which the toroidal type continuously variable transmission 1 is mounted can be prevented.

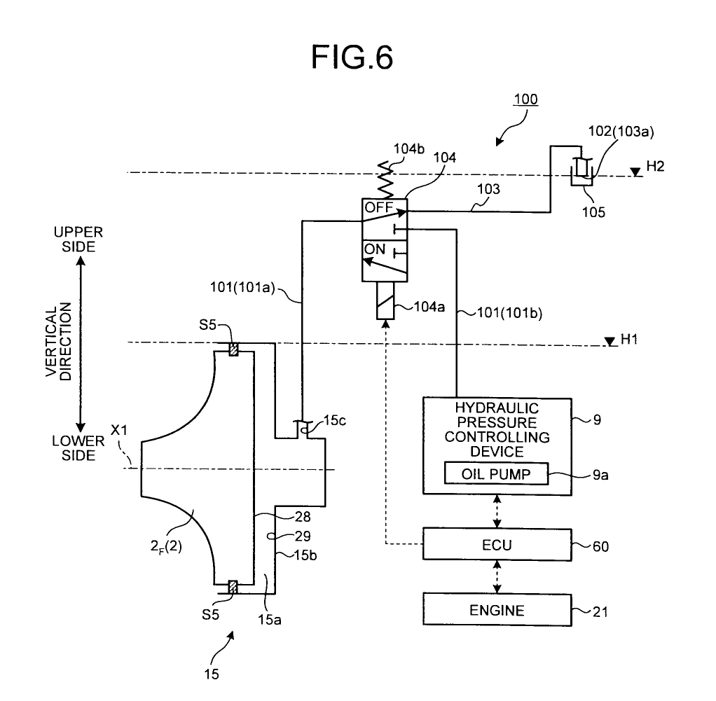

Note that FIG. 5 shows the coupling oil passage 101 assuming that it is partly positioned upward in the vertical direction of the vertical direction position H2 of the release opening 103a. However, it is more preferable to configure the nip-pressure generation hydraulic chamber 15a, the coupling oil passage 101, and the hydraulic pressure controlling device 9 so that they are positioned downward of the vertical direction position H2 of the release opening 103a acting as the release unit 102 in their entireties. More specifically, as shown in FIG. 6, when the pressure release mechanism 100 is configured so that the release opening 103a acting as the release unit 102 is positioned on an uppermost side in the vertical direction in the positional relation thereof to the nip-pressure generation hydraulic chamber 15a, the coupling oil passage 101, and the hydraulic pressure controlling device 9, the configuration is more preferable because the portions in which the working oil remains as it is in the filled state are increased in the nip-pressure generation hydraulic chamber 15a, the coupling oil passage 101, and the hydraulic pressure controlling device 9.

Further, when the engine 21 is placed in the temporary stop state in the so-called idling stop control, since the switch valve 104 of the pressure release mechanism 100 is controlled to the close state by the ECU 60, that is, the switch valve 104 is kept in the close state, the toroidal type continuously variable transmission 1 is kept in the shut-off state that the release of the hydraulic pressure of the working oil of the nip-pressure generation hydraulic chamber 15a via the release opening 103a acting as the release unit 102 is shut off. At the time, in the toroidal type continuously variable transmission 1, although the drive of the oil pump 9a is also stopped because the engine 21 is placed in the temporary stop state, since the release of the hydraulic pressure of the working oil of the nip-pressure generation hydraulic chamber 15a via the release opening 103a acting as the release unit 102 is also kept in the shut-off state because the switch valve 104 is kept in the close state, a working oil supply system from the hydraulic pressure controlling device 9 to the nip-pressure generation hydraulic chamber 15a including the coupling oil passage 101 basically configures a close circuit as a system closed to the outside. Therefore, the hydraulic pressure of the working oil which remains in and is filled with the working oil supply system from the hydraulic pressure controlling device 9 to the nip-pressure generation hydraulic chamber 15a that configures the close circuit is naturally reduced via various gaps which may exist in the working oil supply system from the hydraulic pressure controlling device 9 to the nip-pressure generation hydraulic chamber 15a including the coupling oil passage 101 and is gradually reduced as compared with the case in which the switch valve 104 is placed in the release state, and thus almost all the working oil itself remains in a state that it is filled with the working oil supply system. The hydraulic pressure of the working oil, which remains in and filled with the working oil supply system from the hydraulic pressure controlling device 9 to the nip-pressure generation hydraulic chamber 15a remains while gradually reduced, for example, until the accelerator pedal is depressed and the engine 21 is restarted after a predetermined period passes corresponding to the stop at the intersection with the stop sign and the like after the engine 21 is temporarily stopped by an idling stop control. Note that when the vehicle does not idly travel in the state, the toroidal type continuously variable transmission 1 controls the transmission ratio to a predetermined transmission ratio by an ordinary transmission shift control.

When the engine 21 restarts from the temporary stop state of the engine 21 in the idling stop control, since the working oil and the hydraulic pressure generated by the working oil remain in the working oil supply system from the hydraulic pressure controlling device 9 to the nip-pressure generation hydraulic chamber 15a including the coupling oil passage 101, the toroidal type continuously variable transmission 1 can promptly increase the hydraulic pressure of the working oil of the nip-pressure generation hydraulic chamber 15a from the hydraulic pressure controlling device 9 via the coupling oil passage 101 by an action of the remaining working oil and pressure generated by the working oil. At the time, the toroidal type continuously variable transmission 1 can more promptly increase the hydraulic pressure of the working oil of the nip-pressure generation hydraulic chamber 15a even in comparison with, for example, a time at which the engine 21 ordinarily starts. As a result, in the toroidal type continuously variable transmission 1, since the hydraulic pressure of the working oil of the nip-pressure generation hydraulic chamber 15a is promptly increased, the nip-pressure press force of the working oil of the hydraulic press mechanism 15 can be promptly increased and thus the nip-pressure, which nips the power roller 4 between the input disc 2 and the output disc 3, can be applied a good responsiveness when the engine 21 starts. With the operation, the toroidal type continuously variable transmission 1 can shift to the transmission shift control performed by the transmission ratio changing unit 5 with a better responsiveness when the engine 21 in the idling stop control restarts. That is, occurrence of a delay of restart and re-departure of the vehicle on which the toroidal type continuously variable transmission 1 is mounted can be prevented.

Note that the toroidal type continuously variable transmission 1 may further dispose an accumulation unit to the working oil supply system from the hydraulic pressure controlling device 9 to the nip-pressure generation hydraulic chamber 15a including the coupling oil passage 101. The accumulation unit keeps a predetermined hydraulic pressure by storing the working oil which flows via the working oil supply system from the hydraulic pressure controlling device 9 to the nip-pressure generation hydraulic chamber 15a. With the configuration, when the engine 21 is placed in the temporary stop state in the so-called idling stop control and the switch valve 104 is kept in the close state, the toroidal type continuously variable transmission 1 can keep the hydraulic pressure of the working oil, which remains in the working oil supply system from the hydraulic pressure controlling device 9 to the nip-pressure generation hydraulic chamber 15a including the coupling oil passage 101, in the predetermined hydraulic pressure for a longer period.

Further, as described above, the toroidal type continuously variable transmission 1 is configured such that the switch valve 104 which configures the pressure release mechanism 100 is placed in the close state when the solenoid 104a is energized (in the ON control state) and placed in the release state when the solenoid 104a is disenergized (in the OFF control state). Accordingly, if a wire of the solenoid 104a is broken or a power source unit, which supplies a current to the solenoid 104a, becomes abnormal, while, for example, the vehicle on which the toroidal type continuously variable transmission 1 is mounted travels, the toroidal type continuously variable transmission 1 can shift the switch valve 104 to the release state and keep the state, that is, can promptly shift the hydraulic pressure of the working oil of the nip-pressure generation hydraulic chamber 15a to a state that the hydraulic pressure is released via the release opening 103a acting as the release unit 102 and can keep the state. As a result, since the transmission of power between the input disc 2, the output disc 3 and the power roller 4 can be shut off, even when the wire of the solenoid 104a is broken or the power source unit which supplies the current to the solenoid 104a becomes abnormal while the vehicle travels, the toroidal type continuously variable transmission 1 can prevent occurrence of the unintentional transmission shift and thus can prevent occurrence of a prompt transmission shift in the above case and can securely prevent occurrence of an abnormal behavior of the vehicle due to a shock and the like caused by, for example, a prompt speed reduction.

According to the toroidal type continuously variable transmission 1 according to the embodiment of the present invention explained above, there are provided the input disc 2 to which the driving force is input, the output disc 3 from which the driving force is output, the power roller 4 interposed between the input disc 2 and the output disc 3, the transmission ratio changing unit 5 which rotatably and tiltably supports the power roller 4 as well as can change the transmission ratio as the rotation speed ratio of the input disc 2 and the output disc 3 by tiltably rotating the power roller 4, the hydraulic press mechanism 15 which can apply the nip-pressure that nips the power roller 4 between the input disc 2 and the output disc 3 by the hydraulic pressure of the working oil supplied from the hydraulic pressure controlling device 9 that controls the hydraulic pressure of the working oil to the nip-pressure generation hydraulic chamber 15a via the coupling oil passage 101, and the pressure release mechanism 100 which is disposed to the coupling oil passage 101 and can release the hydraulic pressure of the working oil of the nip-pressure generation hydraulic chamber 15a via the release unit 102 in response to the operation state, wherein the pressure release mechanism 100 is configured such that the release unit 102 is positioned upward in the vertical direction of the nip-pressure generation hydraulic chamber 15a in the state it is mounted on the vehicle.

Accordingly, the toroidal type continuously variable transmission 1 can promptly reduce the nip-pressure press force of the working oil of the hydraulic press mechanism 15 by that the pressure release mechanism 100 releases the hydraulic pressure of the working oil of the nip-pressure generation hydraulic chamber 15a via the release unit 102 in response to the operation state. As a result, since the toroidal type continuously variable transmission 1 can shut off the transmission of power between the input disc 2, the output disc 3 and the power roller 4 with a good responsiveness, the toroidal type continuously variable transmission 1 can prevent the unintentional transmission shift. In the toroidal type continuously variable transmission 1, since the release unit 102 is positioned at least upward in the vertical direction of the nip-pressure generation hydraulic chamber 15a, when the hydraulic pressure of the working oil of the nip-pressure generation hydraulic chamber 15a is released, the working oil remains in the portions downward in the vertical direction of the vertical direction position H2 of the release unit 102 in the nip-pressure generation hydraulic chamber 15a, the coupling oil passage 101, and the hydraulic pressure controlling device 9. Accordingly, when the nip-pressure press force of the working oil of the hydraulic press mechanism 15 is applied again, the toroidal type continuously variable transmission 1 can promptly increase the hydraulic pressure of the working oil of the nip-pressure generation hydraulic chamber 15a and thus can apply the nip-pressure, which nips the power roller 4 between the input disc 2 and the output disc 3, with a good responsiveness. That is, in the toroidal type continuously variable transmission 1, the pressure release mechanism 100 can release the hydraulic pressure of the working oil of the nip-pressure generation hydraulic chamber 15a via the release unit 102 as well as the release unit 102 is positioned at least upward in the vertical direction of the nip-pressure generation hydraulic chamber 15a. As a result, the unintentional transmission shift can be appropriately prevented and the responsiveness of reduction and return of the hydraulic pressure of the nip-pressure generation hydraulic chamber 15a can be improved at the same time, thereby the unintentional transmission shift can be appropriately prevented. Further, in comparison with, for example, a case in which the unintentional transmission shift is prevented by that a tiltably rotation of the power roller 4 is regulated by preventing the rotation of the trunnion 6 about the rotation axis X3 by causing the trunnion 6 to be friction-engaged with an abrasion member, since the toroidal type continuously variable transmission 1 of the embodiment can also prevent, for example, generation of abrasion powder of the abrasion member, the toroidal type continuously variable transmission 1 can appropriately prevent the unintentional transmission shift also in the point.

Further, according to the toroidal type continuously variable transmission 1 according to the embodiment of the present invention explained above, when the engine 21, which generates the driving force, is placed in the stop state, the pressure release mechanism 100 places the hydraulic pressure of the working oil of the nip-pressure generation hydraulic chamber 15a in the release state that the hydraulic pressure is released via the release unit 102, whereas when the engine 21 is placed in the working state, the pressure release mechanism 100 places the hydraulic pressure of the working oil of the nip-pressure generation hydraulic chamber 15a in the shut-off state that the release of the hydraulic pressure is shut off via the release unit 102. Accordingly, in the toroidal type continuously variable transmission 1, when the pressure release mechanism 100 places the hydraulic pressure of the working oil of the nip-pressure generation hydraulic chamber 15a in the release state that the hydraulic pressure is released via the release unit 102 at the time the engine 21 is the stop state, the transmission of power between the input disc 2, the output disc 3 and the power roller 4 is shut off. Accordingly, even if the drive wheels 27 are rotated and the output disc 3 is also rotated because the vehicle on which the toroidal type continuously variable transmission 1 is mounted is pulled, idly travels, and the like, the unintentional transmission shift can be prevented and thus it can be prevented that startability is deteriorated by the insufficient amount of torque and the like. Further, in the toroidal type continuously variable transmission 1, when the engine 21 is placed in the working state, since the pressure release mechanism 100 places the hydraulic pressure of the working oil of the nip-pressure generation hydraulic chamber 15a in the shut-off state that the release of the hydraulic pressure is shut off via the release unit 102, the transmission of power between the input disc 2, the output disc 3 and the power roller 4 becomes possible and thus the transmission ratio can be appropriately changed and fixed by the transmission ratio changing unit 5.

Further, according to the toroidal type continuously variable transmission 1 according to the embodiment of the present invention explained above, when the engine 21, which generates the driving force, is placed in the temporary stop state in the idling stop control in which the idling operation is automatically stopped, the pressure release mechanism 100 places the hydraulic pressure of the working oil of the nip-pressure generation hydraulic chamber 15a in the shut-off state that the release of the hydraulic pressure is shut off via the release unit 102. Accordingly, in the toroidal type continuously variable transmission 1, when the engine 21 is placed in the temporary stop state in the idling stop control, since the hydraulic pressure of the working oil of the nip-pressure generation hydraulic chamber 15a is kept to the shut-off state that the release of the hydraulic pressure is shut off via the release unit 102, the hydraulic pressure of the working oil remains in the working oil supply system from the hydraulic pressure controlling device 9 to the nip-pressure generation hydraulic chamber 15a including the coupling oil passage 101 during a period until the engine 21 restarts. Thus, when the engine 21 restarts from the temporary stop state of the engine 21 in the idling stop control, the toroidal type continuously variable transmission 1 can promptly increase the hydraulic pressure of the working oil of the nip-pressure generation hydraulic chamber 15a and thus can apply the nip-pressure that nips the power roller 4 between the input disc 2 and the output disc 3 with a better responsiveness. With the operation, since the toroidal type continuously variable transmission 1 can shift to the transmission shift control performed by the transmission ratio changing unit 5 with a better responsiveness when the engine 21 in the idling stop control starts, the occurrence of the delay of restart and re-departure of the vehicle on which the toroidal type continuously variable transmission 1 is mounted can be prevented.

Further, according to the toroidal type continuously variable transmission 1 according to the embodiment of the present invention explained above, the pressure release mechanism 100 includes the branch release oil passage 103 whose one end side can communicate with the coupling oil passage 101 as well as whose release opening 103a on the other end side configures the release unit 102. Accordingly, since the release opening 103a acting as the release unit 102 is positioned upward in the vertical direction of the nip-pressure generation hydraulic chamber 15a, the toroidal type continuously variable transmission 1 can prevent the unintentional transmission shift and can improve the responsiveness of reduction and return of the hydraulic pressure of the nip-pressure generation hydraulic chamber 15a at the same time, thereby the unintentional transmission shift can be appropriately prevented.

Further, according to the toroidal type continuously variable transmission 1 according to the embodiment of the present invention explained above, the pressure release mechanism 100 includes the switch valve 104 which can switch the nip-pressure generation hydraulic chamber 15a to the close state, in which the nip-pressure generation hydraulic chamber 15a is connected to the hydraulic pressure controlling device 9, and to the release state that the nip-pressure generation hydraulic chamber 15a is connected to the release unit 102. Accordingly, when the switch valve 104 of the pressure release mechanism 100 is placed in the close state that the switch valve 104 connects the nip-pressure generation hydraulic chamber 15a to the hydraulic pressure controlling device 9, the toroidal type continuously variable transmission 1 can place the hydraulic pressure of the working oil of the nip-pressure generation hydraulic chamber 15a in the shut-off state that the release of the hydraulic pressure is shut off via the release unit 102, and when the switch valve 104 of the pressure release mechanism 100 is placed in the release state that the switch valve 104 connects the nip-pressure generation hydraulic chamber 15a to the release unit 102, the toroidal type continuously variable transmission 1 can place the hydraulic pressure of the working oil of the nip-pressure generation hydraulic chamber 15a in the release state that the hydraulic pressure is released via the release unit 102.

Further, according to the toroidal type continuously variable transmission 1 according to the embodiment of the present invention explained above, the switch valve 104 is configured of the electromagnetic valve which is placed in the close state when energized and placed in the release state when disenergized. Accordingly, even if, the wire of the solenoid 104a of the switch valve 104 is broken or the power source unit which supplies the current to the solenoid 104a becomes abnormal while, for example, the vehicle on which the toroidal type continuously variable transmission 1 is mounted travels, since the toroidal type continuously variable transmission 1 can shut off the transmission of power between the input disc 2, the output disc 3 and the power roller 4 by that the switch valve 104 shifts to the release state and the hydraulic pressure of the working oil of the nip-pressure generation hydraulic chamber 15a promptly shifts to the state that the hydraulic pressure is released via the release unit 102, the toroidal type continuously variable transmission 1 can prevent occurrence of a prompt transmission shift.

Further, according to the toroidal type continuously variable transmission 1 according to the embodiment of the present invention explained above, the switch valve 104 is positioned upward in the vertical direction of the nip-pressure generation hydraulic chamber 15a in the state that it is mounted on the vehicle. Accordingly, since the switch valve 104 is positioned upward in the vertical direction of the nip-pressure generation hydraulic chamber 15a, even if the working oil leaks from, for example, the switch valve 104, the toroidal type continuously variable transmission 1 can cause the working oil to securely remains in the portions downward in the vertical direction of at least the vertical direction position of the portions from which the working oil leaks in the nip-pressure generation hydraulic chamber 15a, the coupling oil passage 101, and the hydraulic pressure controlling device 9.

Further, according to the toroidal type continuously variable transmission 1 according to the embodiment of the present invention explained above, the transmission ratio change unit 5 moves the power roller 4 together with the trunnion 6 from the neutral position with respect to the input disc 2 and the output disc 3 to the transmission shift position and tiltably rotates the power roller 4 by that the transmission shift control press force is applied to the trunnion 6 which support the power roller 4 by the hydraulic pressure of the working oil. The hydraulic pressure controlling device 9 includes the oil pump 9a which can pressurize the working oil by being driven in association with the rotation of the crank shaft 21a of the engine 21 that generates the driving force, and the pressure release mechanism 100 places the hydraulic pressure of the working oil of the nip-pressure generation hydraulic chamber 15a in the release state that the hydraulic pressure is released via the release unit 102 in the operation state that the transmission shift control press force cannot acts on the trunnion 6. Accordingly, when the engine 21 is placed in the ordinary stop state and the drive of the oil pump 9a is placed in the stop state, the toroidal type continuously variable transmission 1 is placed in the operation state that the transmission shift control press force cannot act on the trunnion 6. At the time, since the toroidal type continuously variable transmission 1 is placed in the release state that the pressure release mechanism 100 releases the hydraulic pressure of the working oil of the nip-pressure generation hydraulic chamber 15a via the release unit 102, the transmission of power between the input disc 2, the output disc 3 and the power roller 4 is shut off. Accordingly, in the operation state that the transmission shift control press force cannot act on the trunnion 6, even if the drive wheels 27 are rotated and thus the output disc 3 is also rotated by that the vehicle on which the toroidal type continuously variable transmission 1 is mounted is pulled, idly travels, and the like, the unintentional transmission shift can be prevented and thus it can be prevented that the startability is deteriorated by the insufficient amount of torque and the like.

Note that the continuously variable transmission according to the embodiment of the present invention described above is by no means limited to the embodiment described above and can be modified within the scope described in the claims. In the above explanation, although the continuously variable transmission is explained as a double cavity toroidal type continuously variable transmission, the continuously variable transmission is not to thereto and may be a single cavity toroidal type continuously variable transmission.

Further, in the above explanation, although it is explained that the original pressure of the working oil which operates the transmission ratio changing means and the original pressure of the working oil which operates the nip-press means are the common original pressure, the original pressures are not necessarily common, and the continuously variable transmission of the present invention may independently include a hydraulic pressure controlling means in each of the transmission ratio changing means and the nip-press means.

Further, in the above explanation, although it is explained that the pressurization means is the mechanical type oil pump which is driven in association with the rotation of the output shaft of the drive source, the pressurization means is not limited thereto and may be an electrically driven type oil pump. Even in the case, the continuously variable transmission of the present invention can appropriately prevent the unintentional transmission shift. That is, when the pressurization means is the electrically driven type oil pump, the transmission shift control press force can be applied to the support means by the electrically driven type oil pump regardless the working state of the drive source. However, in the case, for example, the predetermined transmission shift control must be continuously performed while the vehicle is pulled, and thus there is a possibility that an amount of electricity consumption may increase. In contrast, in the continuously variable transmission of the present invention, since the transmission of power between the input disc 2, the output disc 3 and the power roller 4 is shut off by that the pressure release mechanism 100 releases the hydraulic pressure of the working oil of the nip-pressure generation hydraulic chamber 15a via the release unit 102, it is not necessary to perform, for example, the transmission shift control while the vehicle is pulled and thus useless electricity consumption can be suppressed. As a result, the continuously variable transmission of the present invention can prevent the unintentional transmission shift and can suppress the useless electricity consumption at the same time and can appropriately prevent the unintentional transmission shift.

Further, in the above explanation, although it is explained that the switch means is configured of the electromagnetic valve which is placed in the close state when energized, whereas it is placed in the release state when disenergized, the switch means is not limited thereto and may be configured of an electromagnetic valve which is placed in the release state when energized, whereas it is placed in the close state when disenergized or may be configured of a means other than the electromagnetic valve.

In the above explanation, although it is explained that the switch means is positioned upward in the vertical direction of the nip-pressure generation hydraulic chamber in the state the switch means is mounted on the vehicle, the switch means may be positioned at the same position as the nip-pressure generation hydraulic chamber or positioned downward in the vertical direction of the nip-pressure generation hydraulic chamber. In the above explanation, in FIG. 5, although a part of the coupling oil passage is illustrated upward in the vertical direction of the nip-pressure generation hydraulic chamber, a disposition of the coupling oil passage is not limited thereto, and the coupling oil passage may be positioned in its entirety downward in the vertical direction of the nip-pressure generation hydraulic chamber. Further, in the above explanation, the release opening 103a acting as the release unit 102 is illustrated so as to face downward in the vertical direction, it may be disposed so as to face upward in the vertical direction or in a horizontal direction.

Further, in the above explanation, the case in which the drive source is placed in the stop state and the drive of the pressurization means is placed in the stop state is exemplified and explained as the case of the operation state that the transmission shift control press force cannot act on the support means. However, the case in which the transmission shift control press force cannot act on the support means is not limited to the above case, and even when, for example, the seal members of the respective sections in the hydraulic pressure controlling means break, since the operation state that the transmission shift control press force cannot act on the support means occurs, a configuration in which the hydraulic pressure of the working oil of the nip-pressure generation hydraulic chamber is released by the pressure release means in the case may be employed. Even in the case, the continuously variable transmission of the present invention can appropriately prevent the unintentional transmission shift.

### INDUSTRIAL APPLICABILITY

As described above, the continuously variable transmission according to the present invention can appropriately prevent the unintentional transmission shift and can be preferably applied to a continuously variable transmission which transmits a driving force from an internal combustion engine and a motor as a drive source to a road surface in an optimum condition in response to a traveling state of a vehicle.

1-8. (canceled)

9. A continuously variable transmission, comprising:
an input disc to which a driving force is input;
an output disc from which the driving force is output;
a power roller interposed between the input disc and the output disc;
a transmission ratio changing unit that rotatably and tiltably supports the power roller as well as can change a transmission ratio as a rotation speed ratio of the input disc and the output disc by tiltably rotating the power roller;
a nip-press unit capable of applying a nip-pressure that nips the power roller between the input disc and the output disc by a pressure of a working medium supplied to a nip-pressure generation hydraulic chamber from a hydraulic pressure controlling unit that controls the pressure of the working medium via a coupling oil passage; and
a pressure release unit that is disposed to the coupling oil passage and can release the pressure of the working medium of the nip-pressure generation hydraulic chamber via a release unit in response to an operation state, wherein
the pressure release unit is configured such that the release unit is positioned upward in a vertical direction of the nip-pressure generation hydraulic chamber in a state that the pressure release unit is mounted on a vehicle.

10. The continuously variable transmission according to claim 9, wherein when a drive source that generates the driving force is in a stop state, the pressure release unit places a pressure of the working medium of the nip-pressure generation hydraulic chamber in a release state that the pressure is released via the release unit, whereas when the drive source is in a working state, the pressure release unit places a pressure of the working medium of the nip-pressure generation hydraulic chamber in a shut-off state that a release of the pressure is shut off via the release unit.

11. The continuously variable transmission according to claim 9, wherein when a drive source that generates the driving force is in a temporary stop state in an idling stop control in which an idling operation is automatically stopped, the pressure release unit places a pressure of the working medium of the nip-pressure generation hydraulic chamber in a shut-off state that a release of the pressure is shut off via the release unit.

12. The continuously variable transmission according to claim 9, wherein the pressure release unit includes a branch release oil passage, where an end side of the branch release oil passage can communicate with the coupling oil passage as well as an opening of the other end side of the branch release oil passage acts as the release unit.

13. The continuously variable transmission according to claim 9, wherein the pressure release unit includes a switch unit that can be switched to a close state that the nip-pressure generation hydraulic chamber is connected to the hydraulic pressure controlling unit and to a release state that the nip-pressure generation hydraulic chamber is connected to the release unit.

14. The continuously variable transmission according to claim 13, wherein the switch unit is configured with an electromagnetic valve that is placed in the close state when energized, whereas placed in the release state when disenergized.

15. The continuously variable transmission according to claim 13, wherein the switch unit is positioned upward in the vertical direction of the nip-pressure generation hydraulic chamber in a state that the switch unit is mounted on a vehicle.

16. The continuously variable transmission according to claim 9, wherein
the transmission ratio changing unit acts a transmission shift control press force on a support unit that supports the power roller by a pressure of the working medium to thereby move the power roller together with the support unit from a neutral position with respect to the input disc and the output disc to a transmission shift position and tiltably rotate the power roller,
the hydraulic pressure controlling unit includes a pressurization unit that can pressurize the working medium by being driven in association with a rotation of an output shaft of a drive source that generates the driving force, and
when in an operation state that the transmission shift control press force cannot act on the support unit, the pressure release unit is placed in a release state that the pressure release unit releases a pressure of the working medium of the nip-pressure generation hydraulic chamber via the release unit.
